(19) United States
(12) Patent Application Publication
(10) Pub. No.: US 2010/0191548 A1
(43) Pub. Date: Jul. 29, 2010

(54) Computer Method and System for Administering Investment Account

(76) Inventors: Daniel P. Herr, South Windsor, CT (US); Mark S. Doherty, Southington, CT (US); Kimberly A. Genovese, East Windsor, CT (US)

Correspondence Address: BARNES & THORNBURG LLP, 600 ONE SUMMIT SQUARE, FORT WAYNE, IN, 46802, US

(21) Appl. No.: 12/694,585

(22) Filed: Jan. 27, 2010

Related U.S. Application Data
(60) Provisional application No. 61/147,570, filed on Jan. 27, 2009.

(51) Int. Cl. G06Q 40/00

(52) U.S. Cl. 705/4; 705/37; 705/36 R; 705/35

(57) ABSTRACT

A computerized method for administering an investment account having an income or withdrawal guarantee and long term care guarantee includes the steps of establishing an investment account having an account balance, allocating a first portion of the account balance to fund a periodic long term care benefit having a long term care benefit guarantee, allocating a second portion of the account to fund a periodic income or withdrawal benefit having an income or withdrawal benefit guarantee, determining an amount of a periodic long term care benefit available for payment of a long term care benefit claims under the long term care benefit guarantee, and determining an amount of a periodic income or withdrawal benefit available for distribution under the income or withdrawal benefit guarantee. The long term care benefit guarantee may include an acceleration of benefits guarantee and an extension of benefits guarantee. A computer system which includes a processor and a program for causing the processor to perform certain steps is also disclosed.

### RELATED APPLICATIONS

The present application is a utility patent application which is related to and claims priority to U.S. Provisional Patent Application No. 61/147,570 filed Jan. 27, 2009, entitled Computer Method and System for Administering Investment Account. The subject matter disclosed in said provisional application is hereby expressly incorporated into the present application.

### FIELD OF THE INVENTION

The present invention relates generally to financial products and services. More particularly, the present invention relates to computer methods and systems for administering an investment account having an income guarantee and a long term care benefits guarantee. In one embodiment, the investment account comprises an annuity product having long term care benefit features. The invention further relates to a computerized method and system for the efficient administration of benefits paid from an investment account, including provisions for guarantees relating to a plurality of benefits, such as income and long term care benefits.

### BACKGROUND AND SUMMARY

One type of investment account commonly used for retirement planning purposes is an annuity. Annuity products of various types are well known. Commonly available annuities include fixed annuities, in which a person (the “annuitant”) exchanges a lump sum for a series of periodic payments over a period certain or a lifetime. Another type of annuity is a variable annuity, in which the annuitant similarly exchanges a lump sum for periodic payments, but in which the amount of the periodic payments may vary in correspondence with the values of underlying investments. Both fixed and variable annuities are available as immediate or deferred annuities. In an immediate annuity, the annuitant begins receiving payments immediately after entering into the annuity contract. In a deferred annuity, there is a relatively long period (usually years) between entry into the contract and receipt of the first of the periodic payments. In a variable annuity, this period of deferral is referred to as the accumulation period, during which time the initial premium grows if investment returns are favorable.

Additional background information relating to annuities and annuity-like accounts can be found in U.S. Pat. No. 7,376,608 which is commonly owned by the present assignee. The complete disclosure of that patent, as well as the complete disclosures of U.S. Pat. No. 7,089,201 and U.S. Pat. No. 6,611,815, both of which are similarly owned by the present assignee, are hereby expressly incorporated herein for all purposes by this reference thereto.

Annuitants buy annuity contracts to protect against the risk of outliving assets. Exchanging a lump sum asset for periodic payments that extend, for example, over a lifetime insures income to the annuitant, regardless of how long he/she lives. In fixed and certain variable annuity products, the annuitant is protected from downside investment risks which are assumed by the entity offering the annuity, and from the “risks” of a longer than expected life span. In exchange, the annuitant gives up access to the lump sum asset which might otherwise be available to fund various expenses, including expenses associated with growing older. Certain types of variable annuities preserve an annuitant's access to some or all of the premium and investment earnings associated with the annuity account while receiving periodic payments. However, such access may be limited and, if limits are exceeded, will usually adversely affect income guarantees under the annuity.

One class of expenses that may significantly impact certain individuals are those associated with chronic illnesses and disabilities, including nursing home care, home health care, assisted living and adult day care. These and other services beyond routine medical and nursing care are often referred to as long term care (LTC). Chronic care expenses can quickly drain assets and irreparably harm or completely destroy an individual's retirement income.

Stand-alone insurance is available to help pay the costs of LTC services, but can be very expensive and policies are known to be subjected to significant rate increases. Under an LTC policy, an insured pays a periodic premium in exchange for guaranteed coverage of certain qualified expenses in the event the insured is unable to perform certain tasks associated with everyday living and is receiving covered services at home or in a qualified facility. Some individuals opt not to purchase LTC insurance, in hope that (or for fear that) such coverage will never be used. However, as life spans increase, the probability of incurring LTC-related expenses before death similarly increases. Thus, an individual concerned about the risks of a longer than expected life span (i.e., many annuity purchasers) may also be concerned about the risks associated with LTC expenses and what those expenses may do to his or her retirement savings. Every individual who does not directly purchase LTC coverage is choosing to self-insure against this risk.

At present, lifetime income guarantees and LTC protection is an either/or proposition within a single contract, or requires an investment in separate insurance and/or annuity contracts. This requires the investor to make a decision on how much to invest in each which may not yield optimal results. Investment performance in one policy cannot increase the guarantees of the other policy. Also, reducing the level of guarantee in one policy to increase the level of guarantee in the other may be difficult or unachievable as well. Existing designs do not allow the acceleration of the annuity account value for both income protection and LTC protection, nor do they provide the desired level of investment leverage. Such designs only provide for an additional level of income for a defined period of time.

Accordingly, a need exists for a product which will address retirees' needs for LTC protection and lifetime income guarantees. The present invention is a computer system and method for effectively and efficiently administering an investment account which provides LTC protection and lifetime income by combining aspects of annuities and LTC benefits and insurance in a unique way.

In this design, a single investment account is established and used to provide guarantees of both lifetime income and long term care benefits. This design leverages the offsetting risks of long term care and longevity. That is, once receiving long term care benefits, the risk of outliving one's assets is greatly reduced. Thus, the single investment account can be selectively leveraged to provide income protection or long term care protection, as warranted by each investor's situation. By utilizing a single investment account, the performance of the entire investment can be leveraged across both guarantees, a result that is likely unachievable if the guarantees were purchased independently, potentially yielding stronger guarantees for both. In addition, the growth in the investment account can be leveraged to pay the fees for the guarantees of both without destroying the value of either guarantee.

Certain embodiments of the invention comprise a computer system and method for administering an investment account having a lifetime income guarantee and a long term care guarantee, whereby a portion of an investment account may be attributable to a lifetime income guarantee and another portion may be attributable to a long term care guarantee, such that distributions under the lifetime income guarantee do not alter or adjust a long term care guarantee and distributions under the long term care guarantee do not alter or adjust a lifetime income guarantee. Certain embodiments provide for continuing distributions under one or both guarantees after the value of the investment account has reached zero, in accordance with the guarantee.

These embodiments include using a computer to perform one or more of the following steps: establishing an investment account; allocating a first portion of an account balance to fund long term care benefits through a long term care acceleration of benefits guarantee; providing additional long term care protection by means of a long term care extension of benefits guarantee; allocating a second portion of an account balance to fund and guarantee a lifetime income or a withdrawal income for current or future periodic distribution; determining a lifetime income guarantee or a withdrawal guarantee; determining a long term care guarantee comprising a long term care acceleration of benefits guarantee and a long term care extension of benefits guarantee; determining a fee or fees for a lifetime income guarantee or a withdrawal guarantee; determining a fee or fees for a long term care acceleration of benefits guarantee; determining a fee or fees for a long term care extension of benefits guarantee; deducting a lifetime income guarantee or a withdrawal guarantee fee or fees from an investment account value or another source identified by the investor; deducting a long term care fee or fees from an investment account value or another source identified by the investor; paying amounts under a lifetime income guarantee or a withdrawal guarantee; adjusting an investment account by amounts paid under the lifetime income guarantee or withdrawal guarantee (the lifetime income guarantee and the long term care guarantee are preferably not adjusted in response to payments under the lifetime income or withdrawal guarantee); paying amounts under a long term care acceleration of benefits guarantee; adjusting an investment account by amounts paid under a long term care acceleration of benefits guarantee (the long term care acceleration of benefits guarantee, the long term care extension of benefits guarantee, and the lifetime income or withdrawal guarantee are preferably not adjusted in response to payments under the long term care guarantee); paying amounts other than amounts under a lifetime income guarantee or a withdrawal guarantee or a long term care benefit guarantee; adjusting a lifetime income guarantee or withdrawal guarantee by or for amounts paid other than amounts under a lifetime income guarantee or a withdrawal guarantee or a long term care benefits guarantee; adjusting a long term care guarantee by or for amounts paid other than amounts under a lifetime income guarantee or a withdrawal guarantee or a long term care benefits guarantee; attributing growth in the investment account to a lifetime income guarantee or withdrawal guarantee and increasing the guarantee accordingly; attributing growth in the investment account to a long term care guarantee and increasing the guarantee accordingly; adjusting a lifetime income guarantee or withdrawal guarantee by inflation, a cost of living adjustment, or another factor; adjusting a long term care benefits guarantee by inflation, a cost of living adjustment, or another factor; reallocating an investment account to decrease a lifetime income guarantee or withdrawal guarantee and increase a long term care benefits guarantee; reallocating an investment account to increase a lifetime income guarantee or withdrawal guarantee and decrease a long term care benefits guarantee.

One embodiment of the subject invention is a computerized method for administering an investment account having an income or withdrawal guarantee and a long term care guarantee. The subject computerized method comprises the steps of establishing an investment account having an account balance and, using a computer, allocating a first portion of the account balance to fund a long term care benefit having a long term care benefit guarantee, allocating a second portion of the account balance to fund an income or withdrawal benefit having an income or withdrawal benefit guarantee, determining an amount of a periodic long term care benefit available for payment of long term care benefit claims under the long term care benefit guarantee, and determining an amount of a periodic income or withdrawal benefit available for distribution under the income or withdrawal benefit guarantee. In one embodiment, the method further comprises the step of deter mining a total amount available for payment of long term care benefit claims under the long term care benefit guarantee. One or both of the periodic amount and the total amount available for payment of long term care benefit claims under the long term care benefit guarantee may be adjusted over the course of the contract to reflect either one or both of an amount of an allowable claim (or claims) and investment results attributable to the first portion of the account balance.

In one embodiment of the subject method, the long term care benefit guarantee comprises a long term care acceleration of benefits guarantee. This embodiment further comprises the step of determining a total amount available for payment of long term care benefit claims under the long term care acceleration of benefits guarantee. This amount may initially be set to an amount that is equal to, or substantially equal to, the amount of the first portion of the account balance. The amount of the long term care acceleration of benefits guarantee may also be periodically adjusted to reflect either one or both of an amount of an allowable claim paid under the long term care acceleration of benefits guarantee and/or investment results attributable to the first portion of the account balance.

In this or other embodiments, the long term care benefit guarantee may comprise a long term care extension of benefits guarantee. In some embodiments, the amount available for payment of long term care benefit claims under the long term care extension of benefits guarantee is equal to the amount available for payment of long term care benefit claims under the long term care acceleration of benefits guarantee multiplied by a positive numerical factor. In particular embodiments, the factor is either one (1) or two (2). Other factors may be used in particular cases. The total amount available for payment of long term care benefit claims under the long term care extension of benefits guarantee may be adjusted to reflect an amount of an allowable claim paid under the long term care extension of benefits guarantee. In this or other embodiments, the subject method may include the step of adjusting the account balance to reflect a fee associated with the long term care benefit guarantee.

Certain embodiments of the computerized method may comprise the step of determining, in response to a long term care benefit claim, an amount of a long term care benefit payment. This step may include the step of comparing the benefit payment amount to the amount of a periodic long term care benefit available for payment of claims under the long term care benefit guarantee. The subject steps may further comprise the steps of determining whether the amount of the long term care benefit payment is payable under the acceleration of benefits guarantee or the extension of benefits guarantee, and adjusting the account balance of the investment account to reflect payment if the amount is payable under long term care acceleration of benefits guarantee.

In certain embodiments, growth in the investment account may be allocated to the first portion of the account balance, and the amount available for payment of long term care benefit claims under the long term care benefit guarantee may be increased. In other embodiments, a first portion of growth in the investment account may be allocated to the first portion of the account balance, and the amount available for payment of long term care benefit claims under the long term care benefit guarantee may be increased accordingly. Certain embodiments may include the step of adjusting one or both of the periodic amount and the total amount available for payment of long term care benefit claims under the long term care benefit guarantee by an adjustment factor. In such embodiments, the adjustment factor may comprise an inflation factor, a cost of living factor, a fixed percentage rate factor, or a variable percentage rate factor.

Certain embodiments of the computerized method may further comprise the steps of reallocating the account balance of the investment account to decrease the first portion of the account balance and to increase the second portion of the account balance, and decreasing one or both of the amount of a periodic long term care benefit, or the total amount, available for payment of long term care benefit claims under the long term care benefit guarantee. Other embodiments may include the steps of reallocating the account balance of the investment account to increase the first portion of the account balance and to decrease the second portion of the account balance, and increasing one or both of the amount of the periodic long teen care benefit or the total amount available for payment of long term care benefit claims under the long term care benefit guarantee. In certain embodiments, the first portion of the account balance may be limited to a maximum of 50% of the total account balance. Other embodiments may include the step of establishing a range comprising a minimum amount and a maximum amount of the first portion of the account balance.

In certain embodiments, the amount a periodic long term care benefit available for payment of long term care benefit claims under the long term care benefit guarantee is fixed after a specified time period. (See, for example, the designs set forth in FIG. 2.) In certain embodiments, the specified time period is five years. In certain embodiments, the amount of a periodic long term care benefit may be fixed after a specified time period, except for increases to reflect growth of the first portion of the account balance.

Certain embodiments include the step of periodically determining an amount of an income or withdrawal benefit distribution. Such embodiments may also include the step of adjusting the account balance of the investment account to reflect payment of the income or withdrawal benefit distribution. These or other embodiments may further comprise the steps of attributing growth in the investment account to the second portion of the account balance, and increasing the amount of a periodic income or withdrawal benefit available for distribution under the income or withdrawal benefit guarantee.

In some embodiments, the amount of a periodic income or withdrawal benefit available for distribution under the income or withdrawal benefit guarantee may be adjusted by an adjustment factor. In specific instances, the adjustment factor may comprise an inflation factor, a cost of living factor, a fixed percentage rate factor, or a variable percentage rate factor.

In a particular embodiment, the periodic income or withdrawal benefit having an income or withdrawal benefit guarantee is a lifetime benefit.

Certain embodiments may comprise the steps of reallocating the account balance of the investment fund to decrease the first portion of the account balance and to increase the second portion of the account balance, and increasing an amount of a periodic income or withdrawal benefit available for distribution under the income or withdrawal benefit guarantee. Alternatively, other embodiments may comprise the steps of reallocating the account balance of the investment fund to increase the first portion of the account balance and to decrease the second portion of the account balance, and decreasing the amount of a periodic income or withdrawal benefit available for distribution under the income or withdrawal benefit guarantee.

Certain embodiments of the subject method may comprise the steps of determining an amount of a distribution other than an income or withdrawal benefit distribution or a long term care benefit payment. Such embodiments may further comprise the step of adjusting the amount of a periodic income or withdrawal benefit available for distribution under the income or withdrawal benefit guarantee in response to the distribution other than an income or withdrawal benefit distribution or a long term care benefit payment. Certain embodiments may further include the step of adjusting the amount of a periodic long term care benefit available for payment of long term care benefit claims under the long term care benefit guarantee in response to said distribution other than an income or withdrawal benefit distribution or a long term care benefit payment.

Certain embodiments of the computerized method may include the step of adjusting the account balance to reflect an additional deposit credited to the investment account. Such embodiments may include the step of adjusting one or both of the long term care benefit guarantee and the income or withdrawal benefit guarantee to reflect the additional deposit.

### BRIEF DESCRIPTION OF THE DRAWINGS

FIG. 1 schematically illustrates one illustrative embodiment of an investment account administered by the computer method and system of the present invention.

FIG. 2 shows five tables which illustrate various payout alternatives for long term care benefits claims beginning in various years.

FIGS. 3-11 are flow charts which illustrate the programming and operation of an illustrative embodiment of the computer method and system of the present invention.

FIGS. 12-15 show tables which illustrate an example with illustrative details of various quantities and values, and examples of calculations performed in one illustrative embodiment of the computer method and system of the present invention.

FIGS. 16 and 17 illustrate the impacts on certain values and quantities of an excess distribution in the illustrative example of FIGS. 12-15.

### DETAILED DESCRIPTION OF ILLUSTRATIVE EMBODIMENTS

The present invention relates to a computerized method and system for the administration of an investment account having several unique and advantageous features. Among other things, the subject investment account can be customized or tailored in particular ways depending upon the circumstances and desires of an individual account owner. Specifically, individualized allocations of account assets to fund lifetime income benefits, on the one hand, or long term care benefits on the other is both possible and practical using the present design. A number of advantages flow from these and other features.

The computerized method is intended to be implemented on computer systems (hardware and software) of the types used to administer insurance and annuity products. In one embodiment, the method may be implemented using the Vantage One application by Computer Sciences Corporation running on a parallel sysplex with two machines or CEC's (Central Electronic Complexes), z/OS 1.9 and JES3, as follows: IBM 2096-WO4 rated at 1264 MIPS capacity (or 316 MIPS per each of four processor engines); IBM 2096-U03 rated at 772 MIPS capacity (or 257 MIPS per each of three processor engines). The programming language used to implement this embodiment is COBOL.

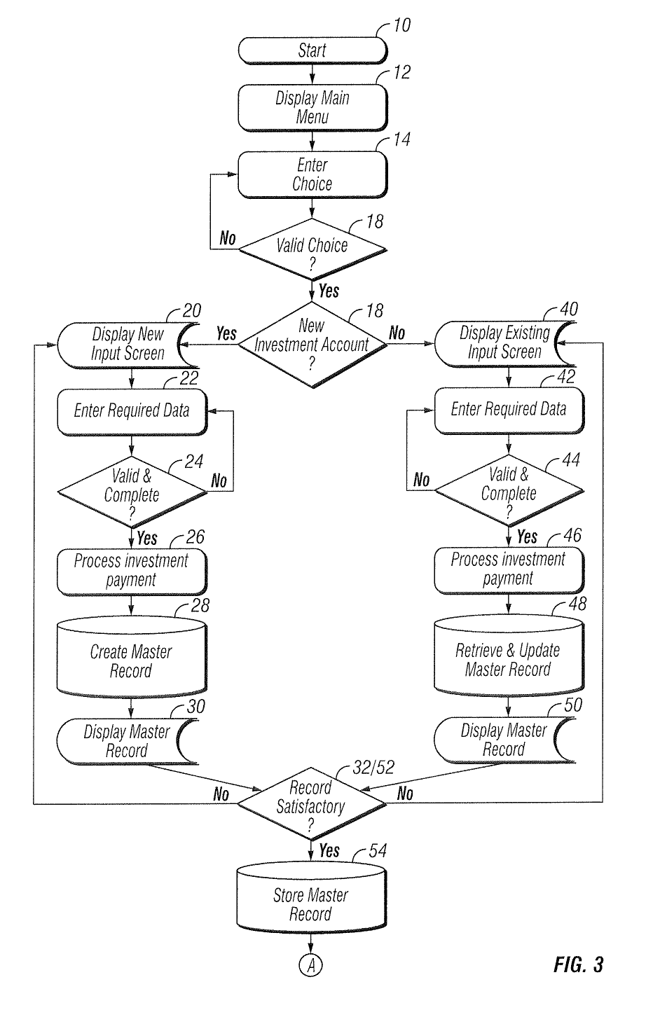

In certain embodiments, including the embodiment illustrated in the flow charts of FIGS. 3-11, the process in intended to be run periodically (e.g., daily) to update the investment accounts being administered. The embodiment described in the flow charts is clearly intended to be illustrative and, when taken with the remainder of the disclosure, to enable those of ordinary skill in the art to practice the invention. Nevertheless, this embodiment is only one of several that could be used to administer investment accounts in accordance with the present invention. Thus, the invention is not intended to be limited to the specific sequence and operations discussed and illustrated, but rather by the scope of the appended claims.

In one embodiment of the invention, long term care protection is offered by way of a rider to a variable annuity policy. In this embodiment, an insurer receives a premium, or purchase payment, for an annuity from an investor. A portion of the premium is designated to fund and guarantee current or future lifetime income. The remainder of the premium is designated to fund and guarantee LTC benefits. The portion of the investment designated to fund and guarantee LTC benefits may be leveraged to provide an LTC extension of benefits guarantee. Charges and benefits associated with the LTC benefits guarantee are paid out of the single investment account. Similarly, lifetime income guarantee charges and distributions are paid out of the single investment account.

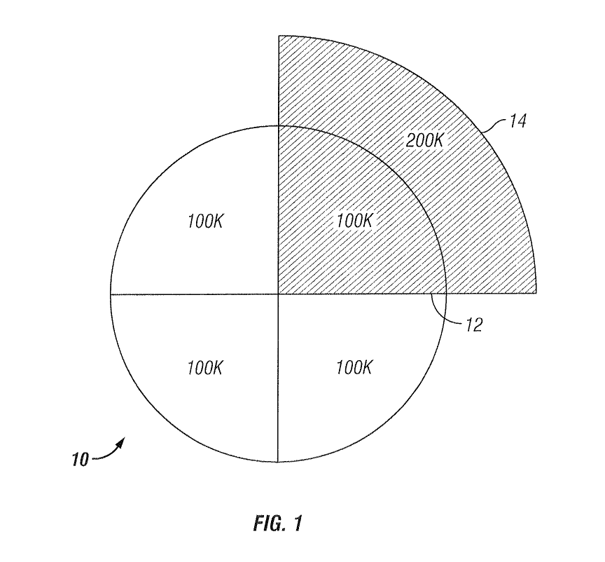

An example of this embodiment is schematically illustrated by FIG. 1. In this example, a client invests an initial amount of $400,000.00. The initial amount is divided into two portions, with $300,000.00 of the initial premium being designated for a lifetime income guarantee, generally indicated by reference numeral 10, and the remaining $100,000 being designated for an LTC acceleration of benefits guarantee, indicated by reference numeral 12.

The LTC acceleration of benefits guarantee is, in this embodiment, supplemented by a $200,000.00 LTC extension of benefits guarantee 14. The portion of the investment designated for the lifetime income guarantee (10) may be invested in fixed assets, equities, etc. to provide a basis for current or future lifetime income amounts in the manner of known annuity plans. The portion of the investment designated for the LTC benefits guarantee (12) may also be invested in fixed assets, equities, etc. to provide a basis for the LTC benefits.

The investment account balance will be used to fund both the lifetime income guarantee and the long term care acceleration of benefits guarantee. Fees for the lifetime income guarantee, the long term care acceleration of benefits guarantee and the long term care extension of benefits guarantee may be assessed to cover the cost of the guarantees. The fees may be deducted directly from the investment account, embedded in the valuation of the investment account or paid for outside of the investment account.

In the product illustrated by FIG. 1, a client can “dial” the amount of LTC protection desired at the time of investment. That is, a greater or lesser amount than is illustrated in FIG. 1 may be designated for the LTC benefit guarantee. In a particular embodiment, the amount of the LTC benefit guarantee can be decreased after rider election and prior to a claim. In one specific embodiment, the client can decrease the amount of coverage after seven years and before claims begin. In this embodiment, decreases can be made only on the rider anniversary. Alternatively, a client may be allowed to “freeze” the amount of the LTC benefit guarantee after a certain time (e.g., five years) has passed.

In one embodiment, the maximum designated for LTC benefits guarantee 12 is limited to 50% of the total premium invested. Certain embodiments may have both minimum and maximum LTC acceleration of benefits and extension of benefits guarantees, with at least the maximum being dependent upon initial premium, amount apportioned to LTC benefits, and/or duration of the LTC coverage. In general, additional deposits may not be designated to the LTC benefit guarantee; however, certain embodiments may allow this and will adjust the LTC benefit guarantee accordingly. Additional deposits will generally be allowed to be designated to the lifetime income guarantee.

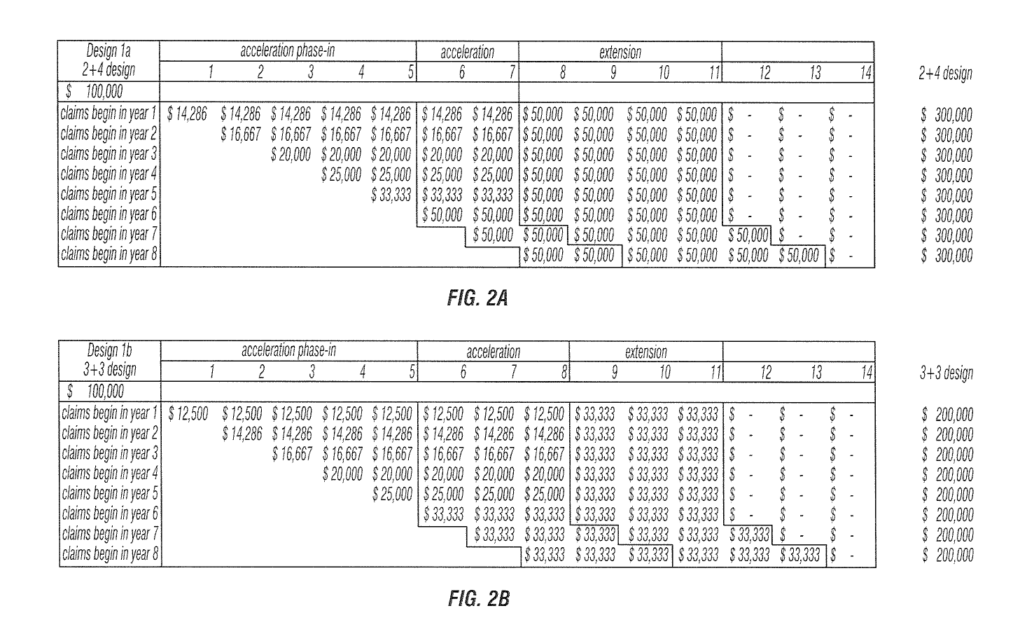

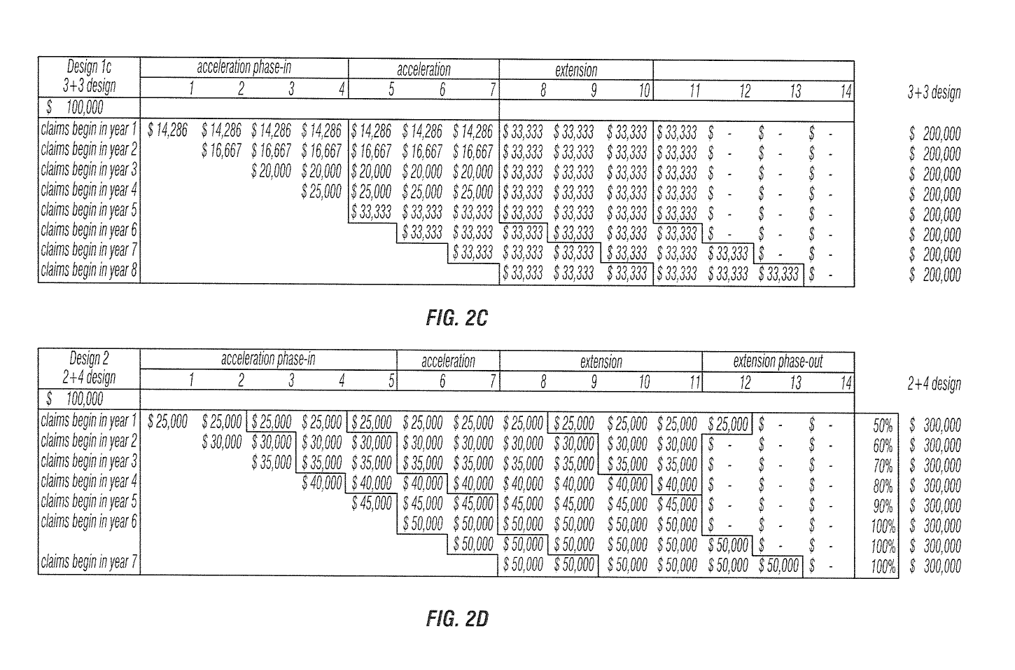

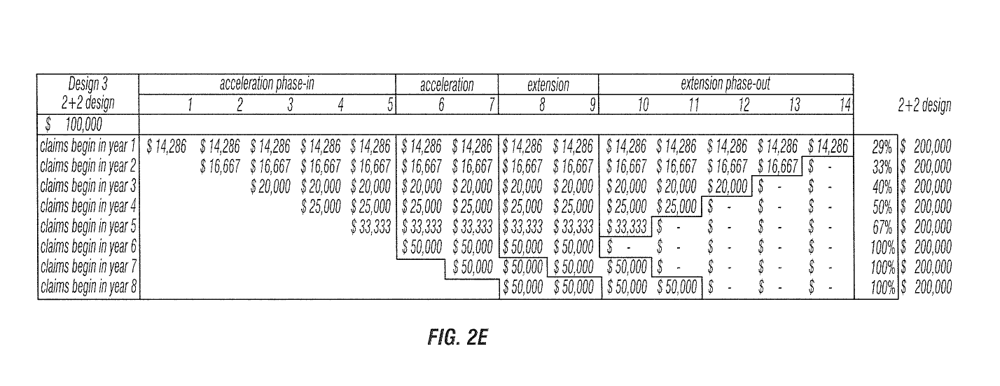

FIG. 2 shows five tables which illustrate various payout alternatives for long term care benefits claims beginning in various years. In the embodiments illustrated in FIG. 2, income benefits and LTC benefits can work independently. These embodiments assume that $100,000 of an initial investment is designated for an LTC acceleration of benefits guarantee. With reference to design 1a, if the client suffers a qualifying event for LTC benefits in years 6, 7 or 8 and submits LTC claims for reimbursement of $50,000.00 per year, the combined LTC acceleration of benefits and extension of benefits will provide for reimbursement of these claims for at least 6 years. In this illustrative embodiment, the acceleration of benefits provides two years of LTC benefits and the extension of benefits provides four years of LTC benefits. Reimbursement of claims under the acceleration of benefits guarantee will reduce the investment account balance; however, if there is at any time insufficient investment account balance to reimburse the LTC claims, the investor will still be guaranteed reimbursement of qualified claims, up to the maximum guaranteed. Reimbursement of the annual amount may be limited to monthly maximums. For example, claims may be reimbursable up to a maximum of $4,166.67 per month, providing a maximum benefit of $50,000.00 per year. In this embodiment, a portion of the investment account equal to the acceleration of benefits guarantee will be allocated to a fixed investment upon receipt of the first claim for reimbursement.

As a tradeoff for limited or simplified underwriting, there may be a long term care benefit eligibility date (e.g., 5 years after the rider effective date) that must be reached before claims will be approved for reimbursement. In these cases, the acceleration of benefit period may not start until the long term care eligibility date is reached. Again, with reference to design 1a, partial acceleration of benefits may be available before the eligibility start date, but full acceleration of benefits will not be available until the eligibility date is reached. As an example, if full acceleration of benefits of $50,000 for two years ($100,000 in total) is available beginning after five years from the rider effective date, partial acceleration of benefits equal to $14,286 may be available each year beginning in the first year after the rider effective date such that if fully utilized in years 1-7, the total acceleration of benefits would remain $100,000. If no acceleration of benefits were used until year three, then partial acceleration of benefits equal to $20,000 may be available each year beginning in the third year after the rider is effective, such that if fully utilized in years 3-7, the total acceleration of benefits would remain $100,000. In any case, the extension of benefits will not be available until the acceleration of benefits is fully exhausted.

Designs 1b and 1c in FIG. 2 are embodiments in which both the LTC acceleration of benefits guarantee and the extension of benefits guarantee are both equal to $100,000 payable over a period of six years at the rate of $33,333 per year. In design 1b, full benefits are available after five years (i.e., beginning in year six). However, if a claim is made in one of the first five years, partial benefits may be available for each year from the date of claim through the end of the acceleration period. For example, if a claim is made in year two, $14,286 per year may be available in each of years 2-8. The extension of benefits would then be available for years 9-11 at a rate of $33,333 per year. In the embodiment illustrated by design 1c, full benefits are available after four years (i.e., in the 5^{th} year and beyond). Partial benefits may be paid for claims beginning in years 1-4 as illustrated in FIG. 2.

Design 2 of FIG. 2 shows another embodiment in which the acceleration benefits equal $100,000 and the extension benefits equal $200,000. Full benefits ($50,000 per year) are available for claims beginning after 5 years. However, for a claim made, for example, in year 4, 80% of the full benefit is payable for years 4-10, with the remainder ($20,000) of the total benefit being payable in year 11. In this design, a claim made in year 1 would result in an annual payment of 50% of the full benefit (i.e., $25,000 per year) for years 1-12.

Design 3 illustrates another embodiment in which the acceleration of benefits and extension of benefits both equal $100,000, payable at a maximum rate of $50,000 per year. Thus, both the acceleration period and the extension period are two years each. Claims made in years 1-5, however, result in lower per year equal payments from the year of claim through the acceleration and extension periods and beyond until the entire benefit ($200,000) has been exhausted. In each of the embodiments shown in FIG. 2, the period before the acceleration period can be characterized as an “acceleration phase-in” period, while payments made after the end of the extension period may be characterized as an “extension phase-out” period. Each of designs 1a, 1b and 1c contemplate acceleration phase-in payments at reduced levels for earlier-made claims beginning with the year of claim and extending through the end of the acceleration period. Payments in the extension periods in each of these embodiments are unaffected by the early-made claims. In contrast, early-made claims in designs 2 and 3 of FIG. 2 result in a reduction of annual payments in accordance with the percentages indicated in each year following the year in which the claim is made, including the years of the extension period. In these embodiments, such payments extend beyond the extension period and into the extension phase-out period.

Lifetime income benefits may or may not be distributed along with the LTC benefits. The income benefits and LTC benefits can work independently. However, if all LTC benefits are exhausted, the product may allow the client to tap the remaining account value (i.e., the non-LTC assets) to replace some or all of the LTC benefit. If income benefits were being simultaneously paid, such benefits would be reduced as the account value is decreased.

Alternatively, a client may be allowed to access the long term care assets as income at some point, if LTC benefits are no longer desired. This option may be desirable to clients who no longer want or need LTC protection, but may benefit from additional income.

The embodiments discussed above in connection with FIG. 2 contemplate a reimbursement plan. That is, actual expenses will be submitted as claims for reimbursement of up to a maximum amount in each year in which benefits are available. It should be noted that each of these embodiments can also operate under a “cash payment” or “per diem” plan. Under such a plan, a periodic benefit payment will be made to the insured without the need to submit actual claims (i.e., incurred expenses) in the amount of the benefit payment.

The products illustrated in FIGS. 1 and 2 may accomplish one or more of the following objectives:

1) The income generating portion of the annuity and the LTC portion can exist and function independently. This addresses the objection some clients have to selecting either an income based annuity product or a long term care product, but not both. Assets can be allocated in a way so as to isolate the LTC assets from the remainder of the account value. However, some flexibility to access those assets in the form of income in the future exists, as discussed below.

2) A client may utilize the full annuity account value for additional LTC support. This feature would result in concurrent reductions in the income guarantee, but allows the investor the flexibility to choose whether LTC protection is more valued than income protection. For products which provide a guaranteed withdrawal benefit in association with the income guarantee, the option to drop or exchange the withdrawal benefit for the ability to draw down the full annuity account value for LTC benefits may be provided.

3) The client may be allowed to access the full annuity account value as income or withdrawals if they subsequently decide they no longer want or need LTC benefits. In this event, the LTC rider and its benefits may be canceled entirely or, alternatively, the LTC rider terminated and any paid-up LTC benefits provided under a separate individual LTC policy.

4) All charges, whether related to income protection or LTC protection, may be deducted from the annuity account value. Alternatively, charges may be billed and paid for outside of the annuity.

5) The product can, if desired, be adjusted to account for inflation. For example, LTC acceleration of benefits and/or the LTC extension of benefits guarantees may grow in accordance with the investments, or may be guaranteed to grow at a fixed cost of living rate, the CPI or other index. In certain embodiments, any excess interest or other investment earnings (i.e., after accounting for all charges and inflation) can be apportioned between the lifetime income guarantee and the long term care guarantee, to the lifetime income guarantee only, or to the long term care guarantee only.

6) Certain embodiments may provide for LTC coverage on two lives. In these instances, either of the two insured's may access an amount up to the monthly maximum of the total LTC benefits available. After the periodic maximum and/or total LTC benefits are exhausted, there would be no additional LTC benefits available, even if only one of the two lives had received benefits. Alternatively, the periodic maximum could be split between the two lives, in equal or unequal amounts.

### DESCRIPTION OF THE FLOWCHARTS

FIGS. 3-11 are flowcharts which illustrate one embodiment of a computerized method and system for administering an investment account in accordance with the invention.

As previously noted, the method and system of the present invention is implemented on a computer system (hardware and software) of the type used to administer annuity products. The software component of the system may be customized as illustrated in the flowcharts, exhibits and other portions of this specification to implement the invention. This embodiment is illustrative only and is not intended to limit the invention which is defined by the appended claims.

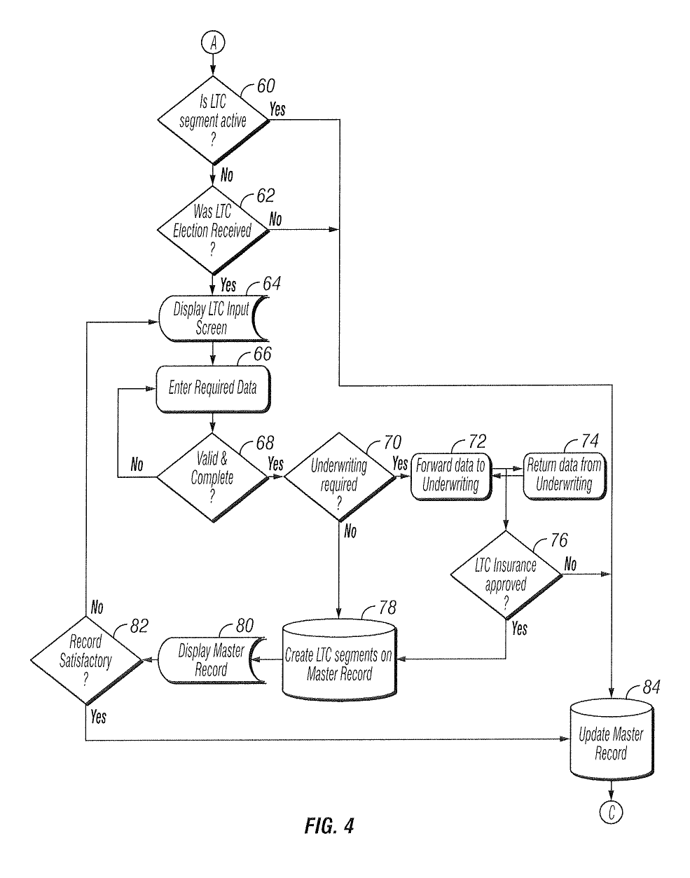

With specific reference to FIG. 4, the computerized process starts at 10 and proceeds to display a main menu from which particular products and/or benefits may be selected (block 12). A choice is entered (block 14) and validated in a decision operation (block 16). If a valid choice is made, the system determines whether or not the subject account is a new or an existing account (block 18). If the account is a new account, an input screen is displayed (block 20). Data required to establish a new account is then entered (block 22). Such data may include information on the account owner, including name, age, sex, address, social security number, state of residence, investment amount, marital status, etc. After entry, the data is validated in a decision operation (block 24). If the data is valid, premium payments received are processed (block 26) and a master record for the investment account is created (block 28). The master record is then displayed for review (block 30). If the record is satisfactory (block 32), it is stored (block 54). If not, the process displays the new data input screen so that new data may be entered or other actions taken to produce a satisfactory master record.

If the account is an existing account, the process proceeds as indicated to display the existing data in an input screen (block 40). Additional or revised data is then inputted (block 42) and checked for validity and completeness (block 44). Such data may include an investment amount, change of address, tax withholding changes, record updates, etc. After new data is entered or existing data revised, premium payments received, if any, are processed (block 46). The master record for the existing account is retrieved and updated (block 48) and then displayed (block 50) for review. If the record is satisfactory (block 52) it is again stored (block 54). The process then proceeds as indicated by A to the first operation in FIG. 4.

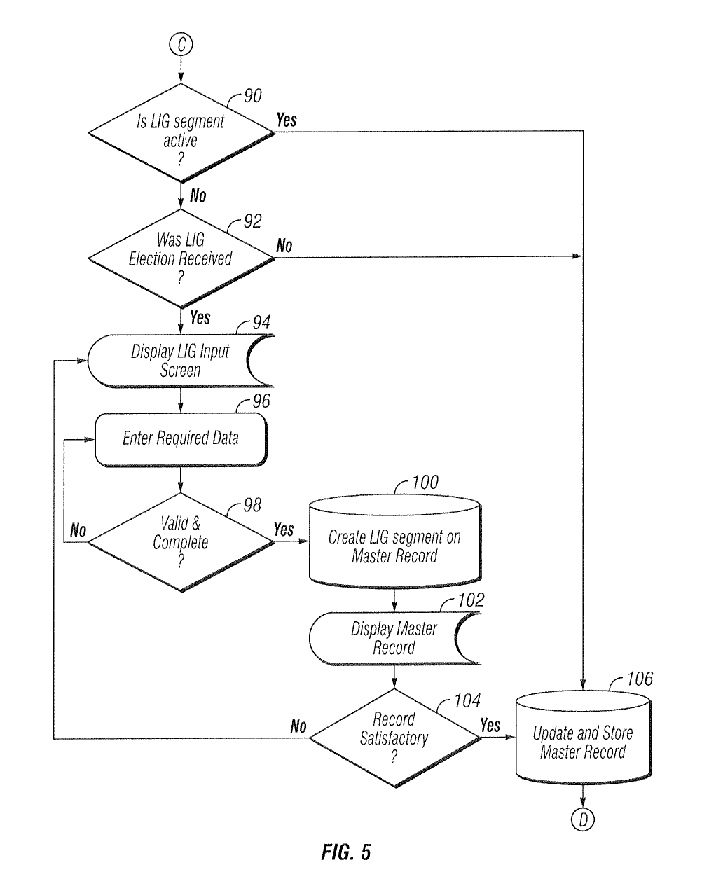

With reference to FIG. 4, the computerized system and method first determines whether a long term care guarantee is active from information in the master record for an individual account. If such a guarantee is active (i.e., if LTC protection is desired and has been elected), the process proceeds as indicated by updating the master record, if necessary (block 84), and then to the top of FIG. 5. If an LTC guarantee is not active, the system checks to determine whether an LTC election has been received since the process last ran (block 62). If not, the system proceeds as indicated to FIG. 5. If an LTC election was received, the system proceeds by displaying the LTC input screen (block 64). Required data is then entered (block 66) and validated (block 68). Such data may include the account owners age, sex, the option elected, and other information. The system then determines whether underwriting is required (block 70). If yes, data is forwarded to underwriting for review (block 72). Additional data may be requested by underwriting (block 74) and exchanged with the system, as needed. If the LTC coverage is not approved by underwriting, the system proceeds as indicated to the top of FIG. 5. If LTC coverage is approved, the system creates an LTC segment on the investment account master record (block 78). If underwriting is not required, the underwriting steps are bypassed and an LTC segment is created, as indicated. The master record is then displayed for review (block 80) and checked for validity and completeness (block 82). If the record is satisfactory, the process proceeds as indicated by updating of the master record (block 84) and then to the top of FIG. 5. If the master record data is not satisfactory, the LTC data input screen is displayed again and the above-described process is repeated.

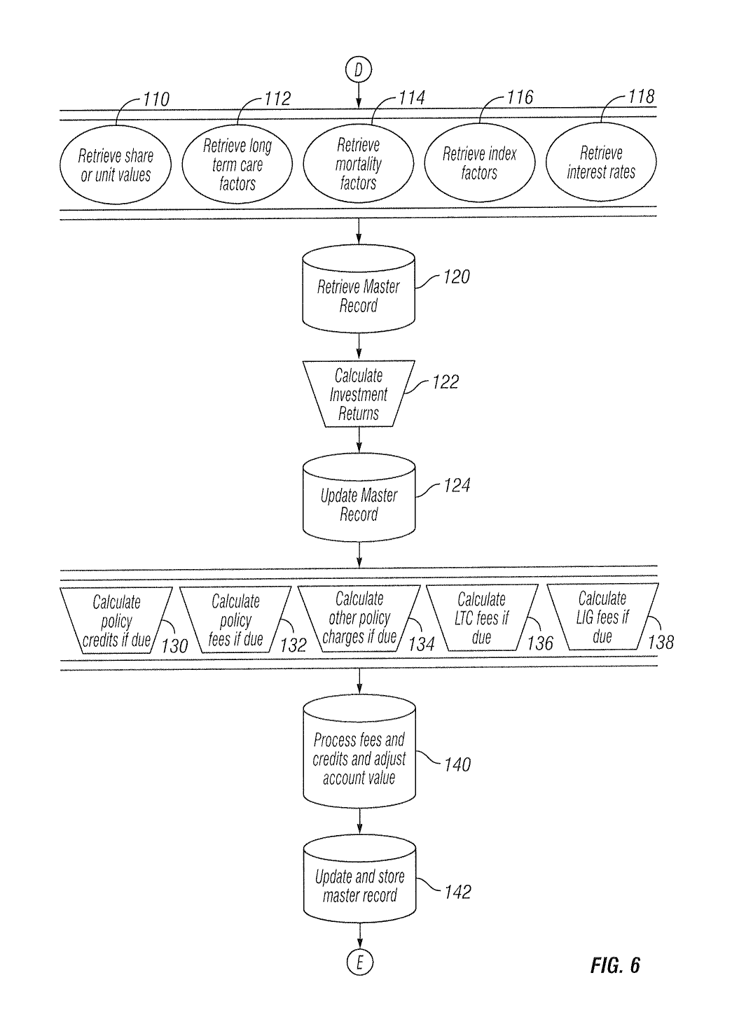

With reference to FIG. 5, the system next determines for each account whether a lifetime income guarantee is active (block 90). If so, the process proceeds by updating and storing the master record, if necessary (block 106), and then to the top of FIG. 6. If a lifetime income guarantee is not active, the system checks to see if an LIG election was received since the process was last run (block 92). If not, the process proceeds as indicated and previously described to the top of FIG. 6. If an LIG election has been received, the LIG data input screen is displayed (block 94). Data is entered (block 96) and validated (block 98). Such data may include distribution rate, age, sex, optional benefits, etc. After all required data is entered and verified, the system creates one or more LIG segments on the master record (block 100). The master record is then displayed for review (block 102). If the record is satisfactory, the process proceeds as indicated to the top of FIG. 6. If the record is not satisfactory, the data entry steps are repeated, as necessary.

With reference to FIG. 6, several items of data are retrieved for use by the system in calculating various quantities. Items of information which may be retrieved include mutual fund share values or accumulation unit values (block 110), long term care rate factors for long term care insurance (block 112), mortality tables/factors for lifetime income guarantees (block 114), various index factors (e.g., CPI, CPI-U, SNP index, bond indices, etc.) (block 116) and various interest rates (e.g., insurance company rates, treasury rates, government and/or corporate bond rates, etc.) (block 118). The master record is then retrieved (block 120) and investment returns are calculated (block 122). The investment returns are calculated based upon the terms of the contract, using, for example, unit or share values, index factors, interest rates, and others of the previously retrieved factors, as necessary. The master record is then updated to reflect the investment return calculations (block 124).

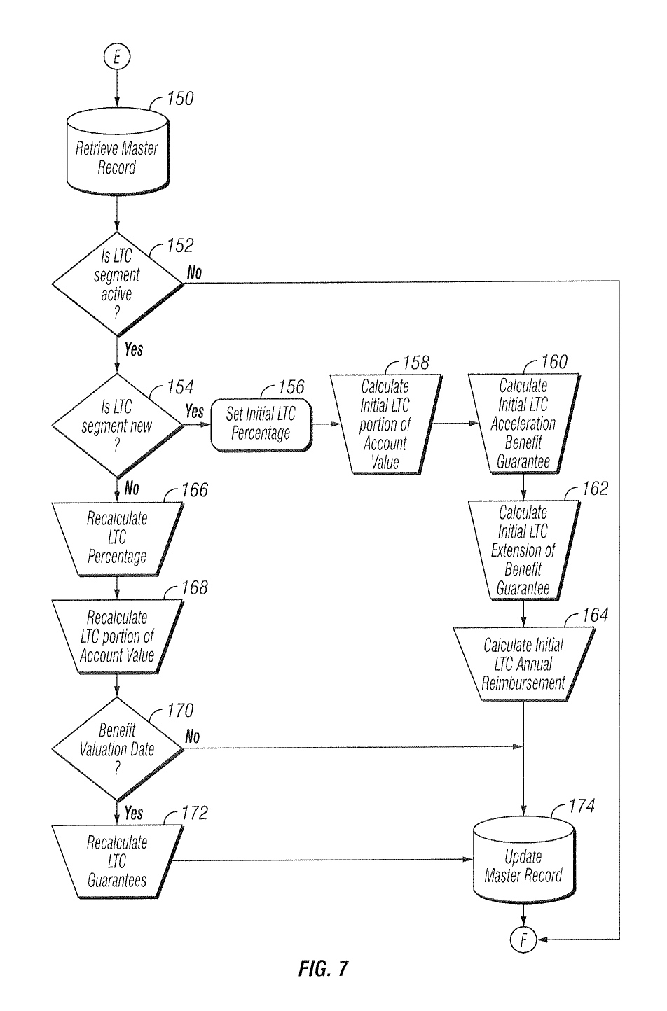

The system and method then proceeds to calculate policy credits, if due, (block 130), policy fees, if due, (block 132), other policy charges, if due (block 134), LTC fees, if due (block 136), and LIG fees, if due (block 138). Policy credits may be calculated as a percentage of account value, a percentage of the original deposit, or in another manner specified in the contract. Policy fees may be set as flat dollar amounts or as a percentage of account value. LTC fees may be determined as a percentage of the acceleration benefit, a percentage of the extension benefit, as a rate per $100,000 of extension benefit based on age/sex, or in any other manner specified in the contract. LIG fees may be determined as a percentage of the guarantees value, a percentage of the withdrawal amount, a percentage of the account value, a daily charge, or in any other manner specified in the contract. After calculation, the fees and credits, if any, are processed and appropriate adjustments are made to the account value (block 140). The master record is then updated and stored (block 142) and the process proceeds as indicated to the top of FIG. 7.

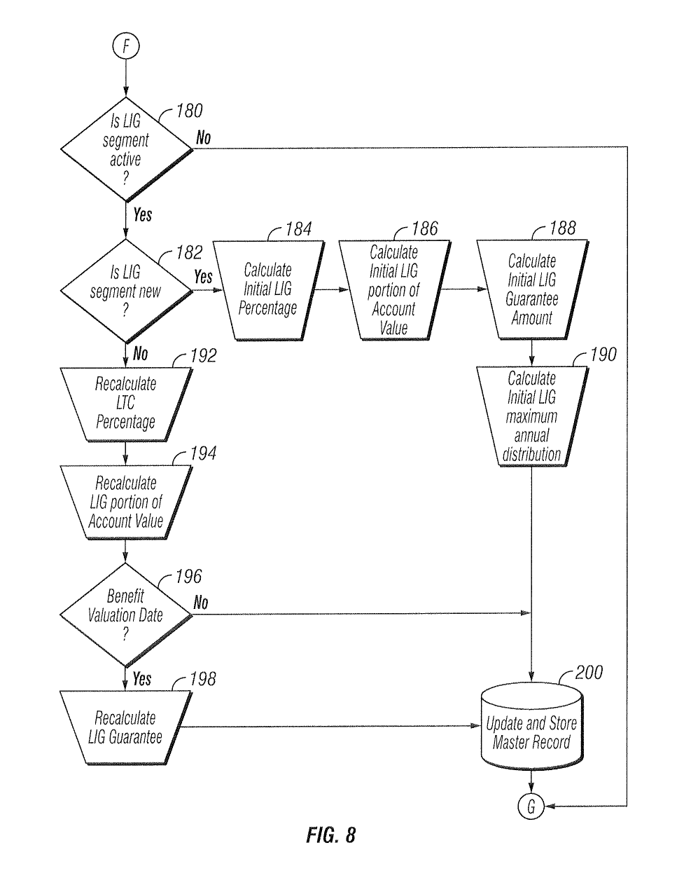

With reference to FIG. 7, the system first retrieves the master record (block 150). A decision operation (block 152) then determines whether an LTC segment is active. If not, the process proceeds as indicated to the top of FIG. 8. If yes, the process determines whether a new LTC segment has been created (block 154). If yes, the system proceeds as indicated to set the initial LTC percentage to the percentage selected or required under the contract (block 156). For example, the LTC percentage may be elected by the investor, required by law, required by company policies, recommended by financial advisor, etc. After the percentage is set, the system calculates an initial LTC account value based on the LTC percentage set and the total account value (block 158). The initial LTC acceleration benefit guarantee based on election data is then calculated (block 160). Data used in this calculation may include LTC account value, duration of the acceleration period, duration of the extension period, optional benefits such as inflation protection, account value growth guarantees or roll up benefits. The process then calculates the initial LTC extension of benefit guarantee based on the election data and the contract (block 162). Factors determined in these calculations may include the amount of acceleration of benefits, the duration of extension benefits, inflation options, etc. Based on election information, the initial LTC annual reimbursement amount is calculated (block 164). The master record is then updated (block 174) and the process proceeds as indicated to the top of FIG. 8.

If the LTC segment is not a new segment, the process of FIG. 7 proceeds as indicated with recalculation of LTC percentage, if required, based on the LTC percentage formula (block 166). If the LTC percentage is recalculated, the process then recalculates the LTC account value (block 168). The process then determines whether the present cycle occurs on a benefit valuation date (block 170). If yes, the system and method recalculates the LTC guarantees based on appropriate factors designated, for example, in the contract (block 172). These factors may include inflation index, SNP index, account value, roll up rate, interest crediting rate, etc. Following recalculation of the LTC guarantees, if necessary, the master record is updated (block 174) and the process proceeds as indicated to the top of FIG. 8.

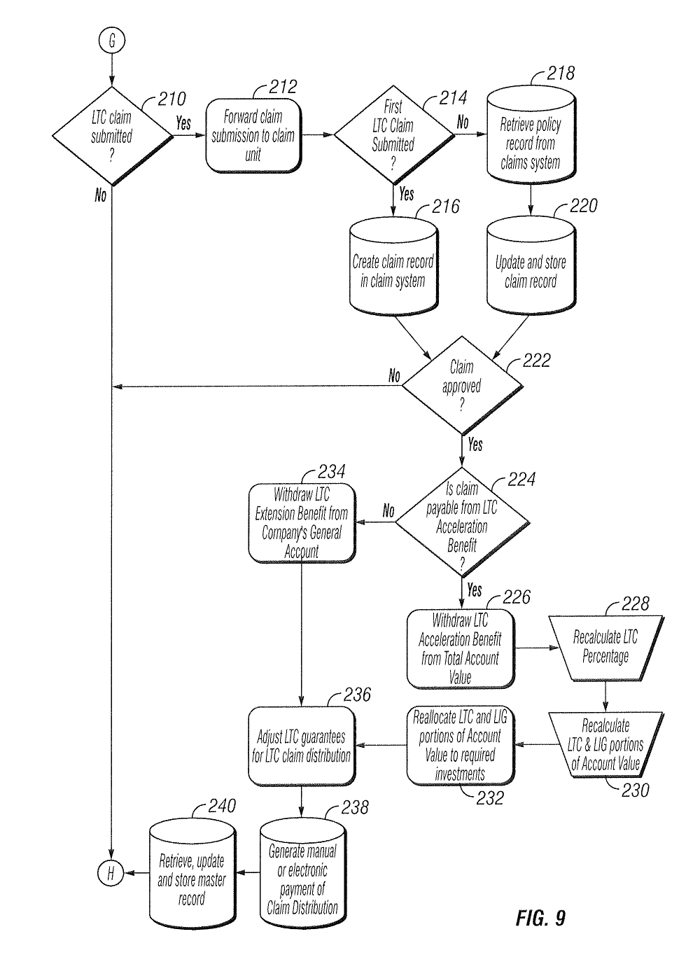

With reference to FIG. 8, the process first determines whether an LIG segment is active (block 180). If not, the process proceeds as indicated to the top of FIG. 9. If yes, the process next determines whether a new LIG segment has been created (block 182). If so, the process calculates the initial LIG percentage (block 184) as one minus the initial LTC percentage referenced above (block 156). The initial LIG percentage is then used to determine the initial LIG account value (i.e., by multiplying the LIG percentage times by the total account value) (block 186). The initial LIG guarantee amount is then calculated (block 188). This calculation is based on election data, such as LIG account value distribution rate, age, sex, etc. The system then calculates the initial LIG maximum annual distribution (block 190). The master record is then updated with the results of these calculations (block 200) and the process proceeds as indicated to the top of FIG. 9.

If no new LIG segment has been created, the system proceeds as illustrated in FIG. 8 to recalculate the LTC percentage, if required, based on the LTC percentage formula (block 192). This is the same calculation previously performed earlier in the process (block 166). The process then recalculates LIG account value (block 194) by multiplying total account value by LIG percentage (i.e., one minus LTC percentage) reflecting all financial transactions. The process then determines whether the cycle is being run on a benefit valuation date (block 196). If not, the master record is updated with the results of the calculations (block 200). If the cycle is run on a valuation date, the process recalculates LIG guarantees (block 198) based on LIG variables and factors (e.g., LIG account value, distribution rate, age, sex, inflation index, S&P index, rollup rate, interest crediting rate, etc.). Following these recalculations, the master record is updated and stored (block 200). The process then moves through the flowchart of FIG. 9.

With reference to FIG. 9, the process determines whether, for a particular account, an LTC claim has been submitted (block 210). If so, the process proceeds as indicated by forwarding the claim submission to the claim unit (block 212). The system and process then determines whether the subject LTC claim is the first, or initial, claim submitted (block 214). If yes, a claim record is created in the claims system (block 216). If no, the policy record is retrieved from the claims system (block 218). After retrieval of the policy record, the record is updated to reflect the new claim (block 220). After creation or retrieval and updating, the claim is forwarded to the claim unit for adjudication (block 222).

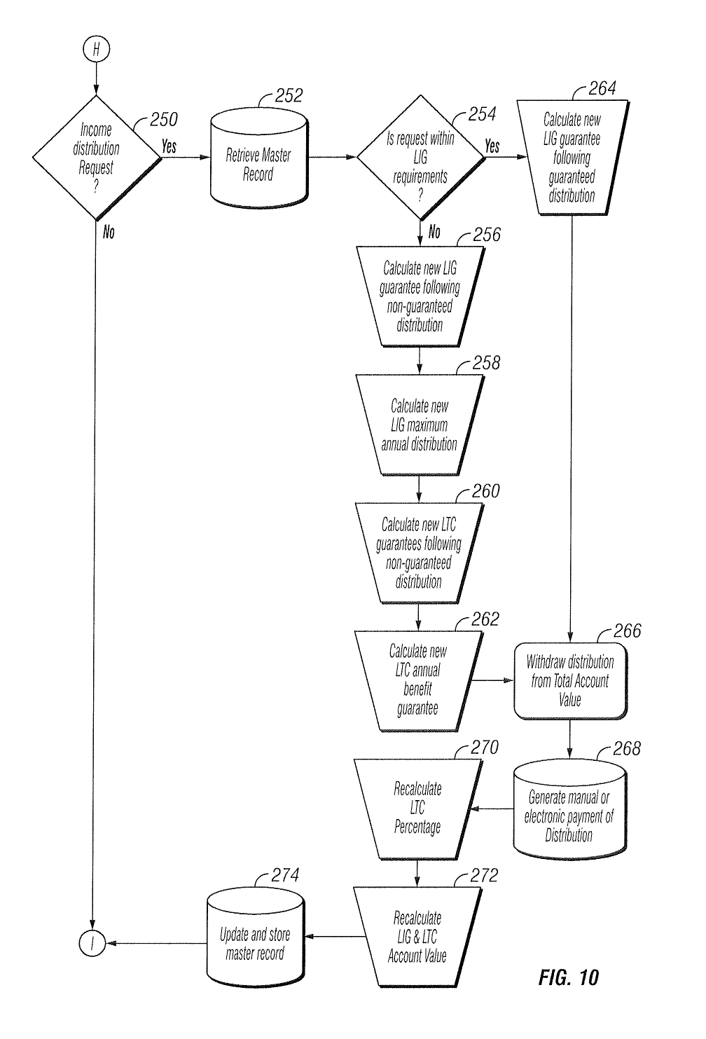

If a particular claim is disapproved, the process proceeds as indicated to the flowchart of FIG. 10. If the claim is approved (block 222), the automated system and process then determines whether the claim is payable from the LTC acceleration benefit (block 224). If yes, the amount of the claim is withdrawn as an LTC acceleration benefit from the total account value (block 226). The process then recalculates the LTC percentage (block 228) and recalculates the LTC and LIG account values based on the recalculated LTC percentage and corresponding LIG percentage (block 230). It should be noted that the LTC and LIG account values are “virtual” account values, and that all distributions and benefits are withdrawn from the total account value. The virtual LTC and LIG account values are tracked in order to allocate gains in the total account value to the respective virtual account values in order to establish any resets in guarantees, or for similar purposes. The LTC and LIG account values are then reallocated to required investments (e.g., the LTC fixed account, conservative model, moderate model, etc.) (block 232).

If the claim is not payable as an LTC acceleration benefit from the total account value, the amount of the claim reimbursement is withdrawn as an LTC extension benefit from the company's general account (block 234). After this withdrawal, or after reallocation of LTC and LIG account values if the claim is payable from the total account value, appropriate adjustments are made to the LTC guarantee amount, acceleration benefits, and extension benefits for the amount of the LTC reimbursement (block 236). A payment is then generated (either manually or electronically) for disbursement to the account owner (block 238). The master record is then retrieved, updated and restored (block 240), and the process proceeds to the flow chart of FIG. 10.

With reference to FIG. 10, the system and method determines whether a lifetime income distribution request has been submitted (block 250). If so, the system retrieves the master record (block 252), and determines whether the request is within the LIG requirements (block 254). If so, the system calculates a new LIG guaranteed amount following a guaranteed distribution (block 264). The distribution is then withdrawn from the total account value (block 266) and a manual or electronic payment in the amount of the distribution is generated (block 268).

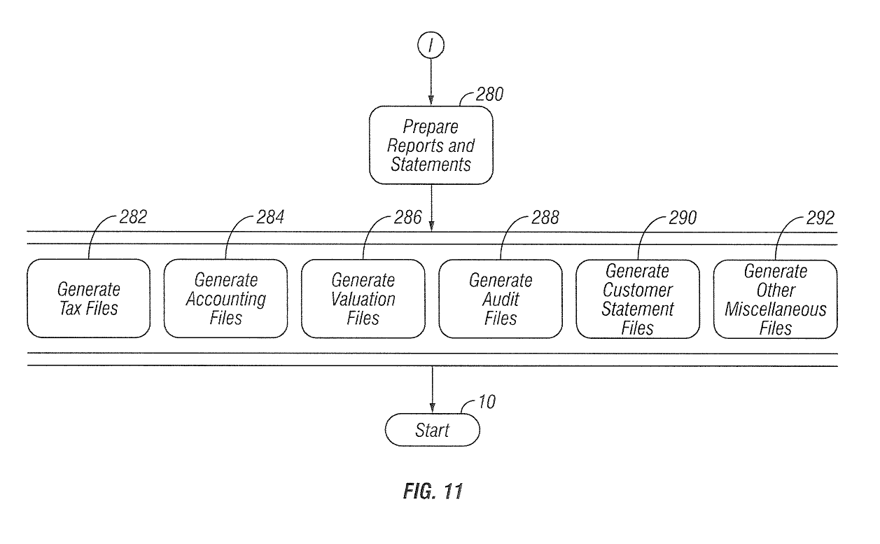

If the requested distribution is not within the LIG requirements, the process calculates the new LIG guaranteed amount following a non-guaranteed distribution (block 256). The system then further calculates a new LIG maximum annual distribution (block 258), and new LTC guarantees (e.g., acceleration benefit, extension benefit, LTC guaranteed amount) following a non-guaranteed distribution (block 260). The system then calculates a new LTC annual benefit guarantee following a non-guaranteed distribution (block 262) (e.g., by adjusting the annual claim guarantee by an amount proportional to the amount withdrawn from the total account value). The distribution amount is then withdrawn from the total account value (block 266), and a manual or electronic payment in the amount of the distribution is generated (block 268). Following payment, the LTC percentage is recalculated (block 270), and the LIG and LTC account values are recalculated (block 272) based on the new LTC percentage. The master record is then updated and stored (block 274). Following this step, or if no distribution request has been submitted, the process flow moves as illustrated to the flow chart of FIG. 11.

With reference to FIG. 11, the computerized method and system prepares reports and statements (block 280), as required or desired. Various files, including tax files, accounting files, valuation files, audit files, customer statement files, and other miscellaneous files are then generated (blocks 282-292). The process then repeats the entire cycle for the next account.

As noted, the computerized process illustrated in the flow charts of FIGS. 3-11 is one illustrative embodiment of a process which would be run periodically (e.g., daily) for each of the accounts being administered. This embodiment is clearly illustrative and represents only one of many such sequences of steps and operations that could be used to administer an investment account in accordance with the present invention. Thus, the invention is not limited to the particular sequence of operations illustrated in FIGS. 3-11, but rather by the scope of the claims.

### DETAILED ILLUSTRATIVE EXAMPLE

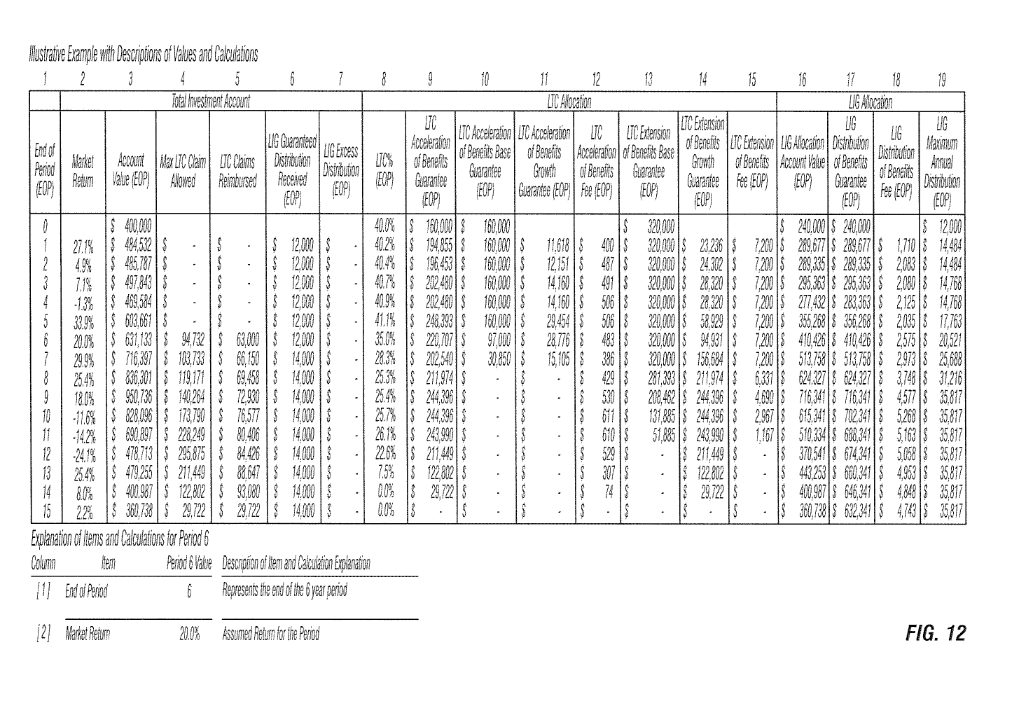

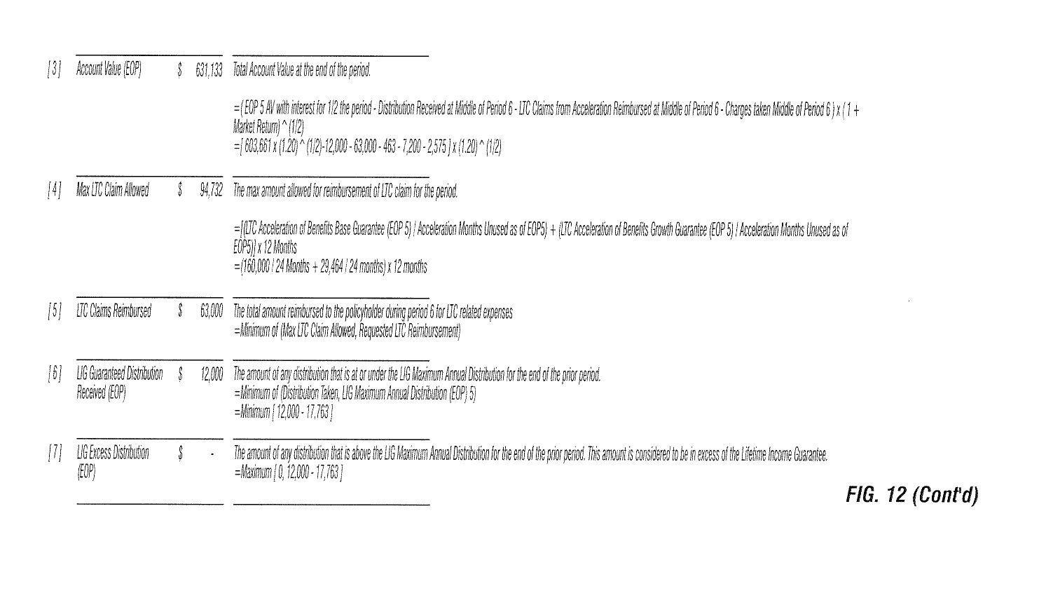

FIGS. 12, 13, 14 and 15 show tables which illustrate an example with illustrative details of various quantities and values discussed above, and examples of calculations performed in one illustrative embodiment of the subject computerized system and method. Specifically, FIGS. 12-15 include a table with hypothetical values illustrating an investment account of the type described herein. With reference to column 1 on the far left, the table illustrates values and calculations for a total of fifteen periods. More or fewer periods may be applicable in the case of individual accounts. Moving to the right, the first section of the table (columns 2-7) relates to the total investment account. The next section (columns 9-15) relates to the LTC portion or allocation of the account. Finally, the last section (columns 16-19) relates to the LIG portion or allocation of the account.

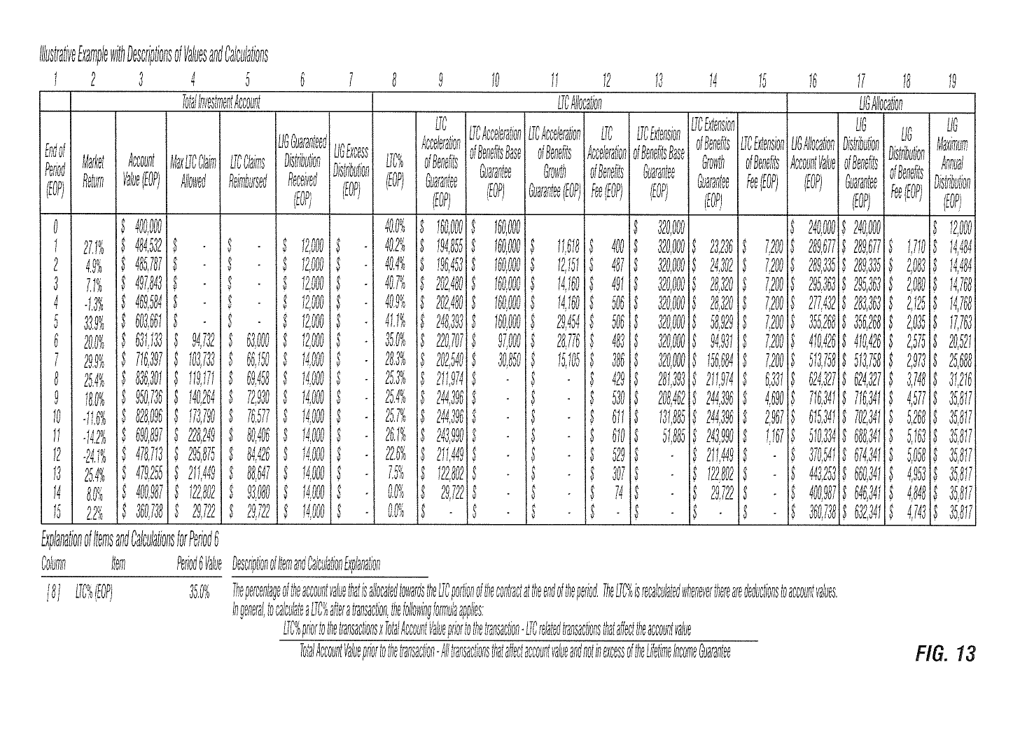

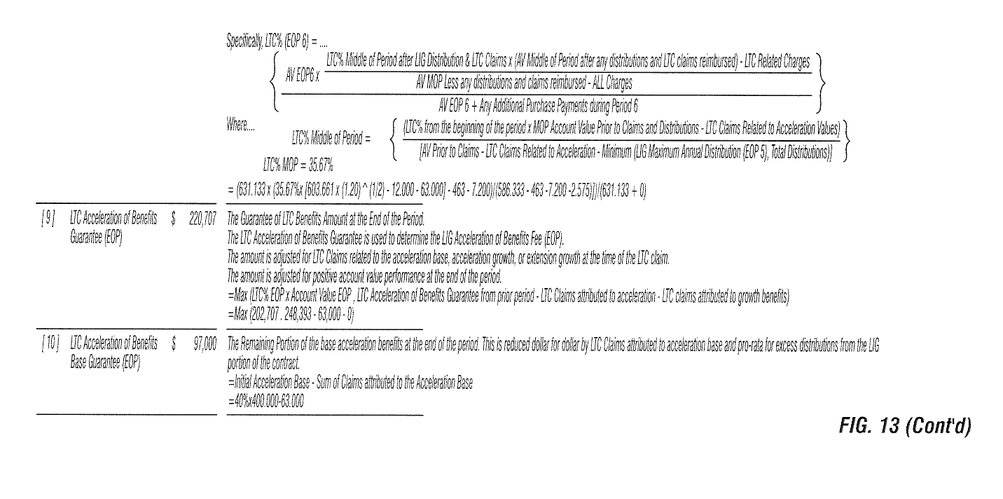

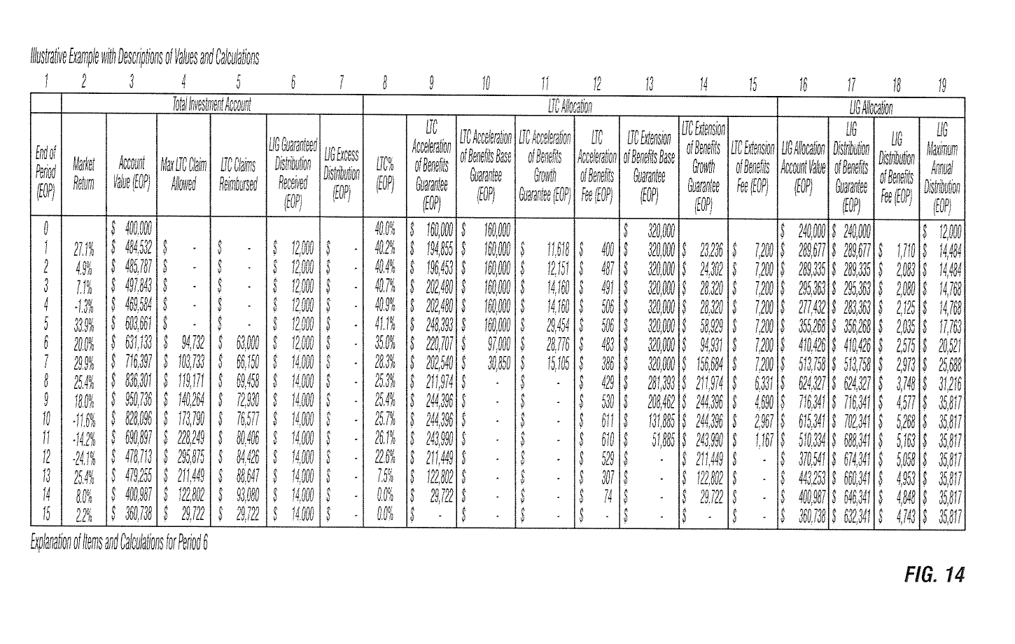

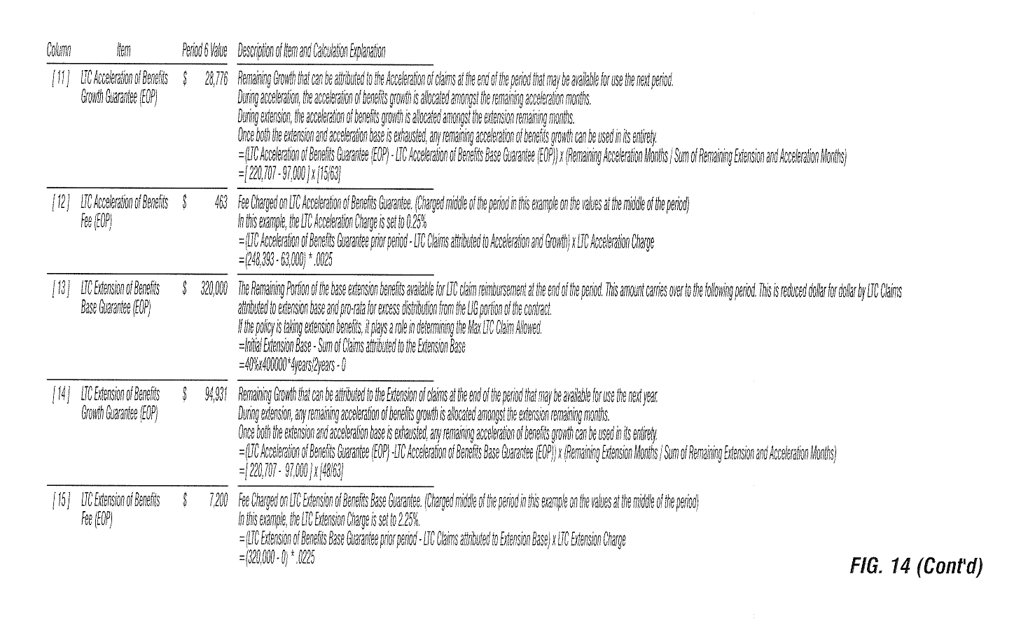

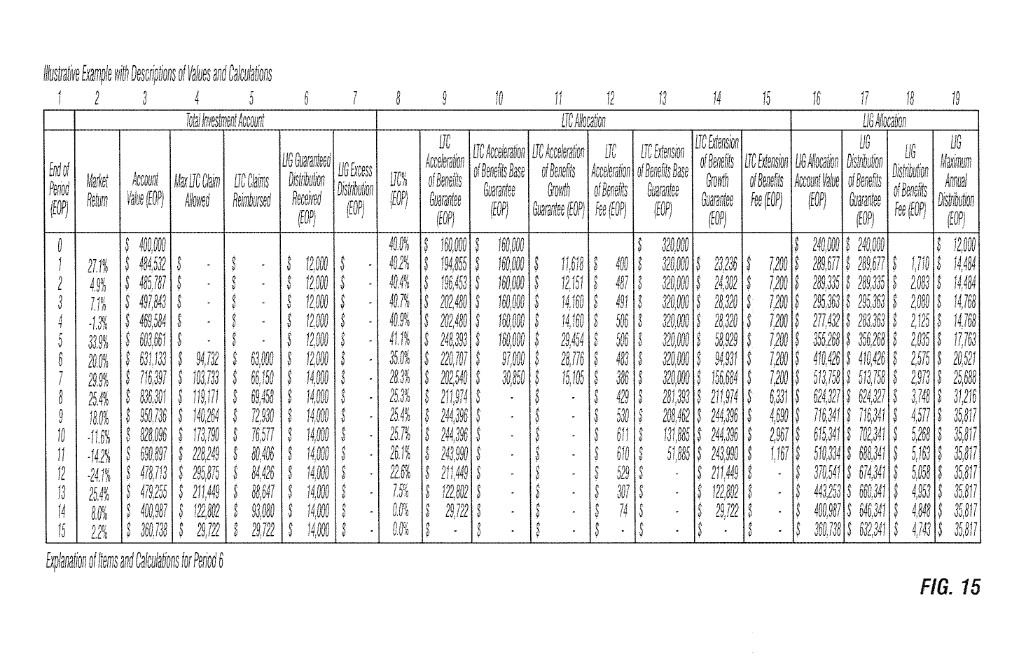

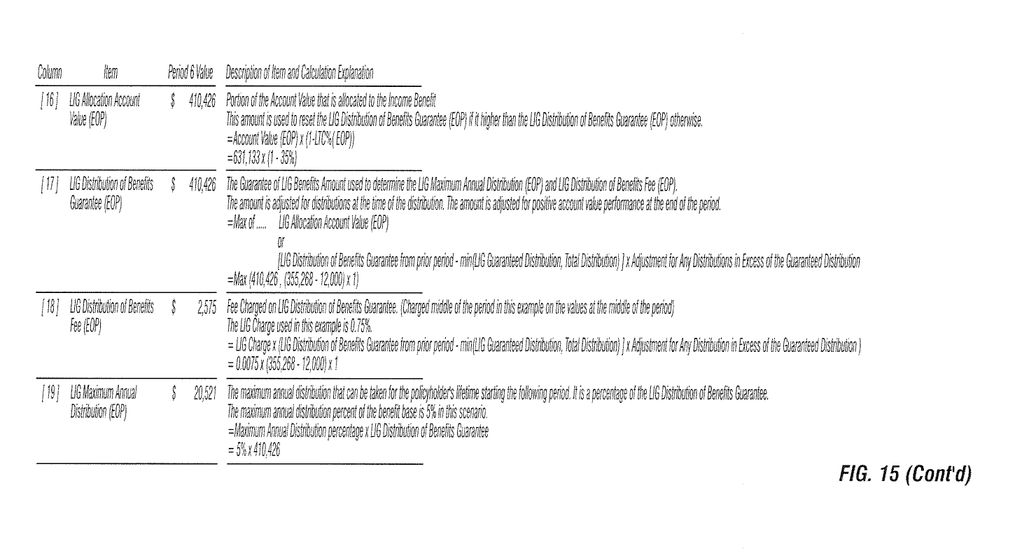

The text below the tables in each of FIGS. 12-15 defines the value in each column or sets forth the algorithm for calculating such value, using period six as an illustrative example. For example, the market return at the end of period six is assumed, for purposes of illustration, to be 20.0% (column 2). The total account value at the end of period six (column 3) is $631,133.00, and is calculated by crediting the account value at the end of period five with “interest” (from column 2) for one-half of the period, minus the $12,000.00 LIG distribution received at the middle of period six (column 6), minus the $63,000.00 LTC claims reimbursed at the middle of period six (column 5), minus charges taken at the middle of period six (columns 12, 15, and 18), times the market return. Similar illustrative calculations are provided for each of the columns in the table. Specifically, calculations for columns 2-7 appear beneath the table of FIG. 1, calculations for columns 8-10 appear below the table in FIG. 13, calculations for columns 11-15 appear below the table in FIG. 14, and calculations for columns 16-19 appear below the table in FIG. 15.

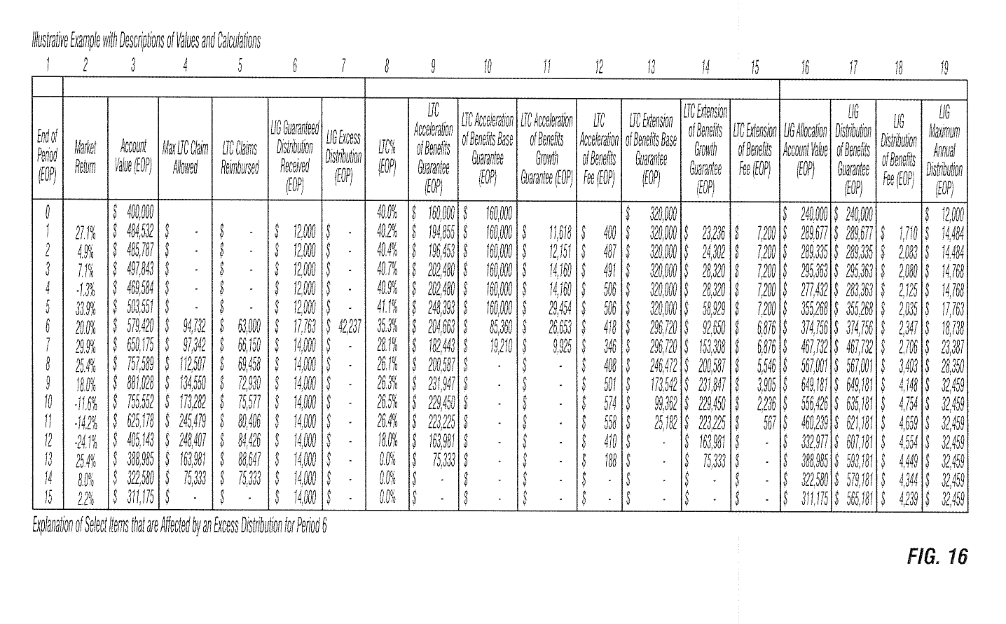

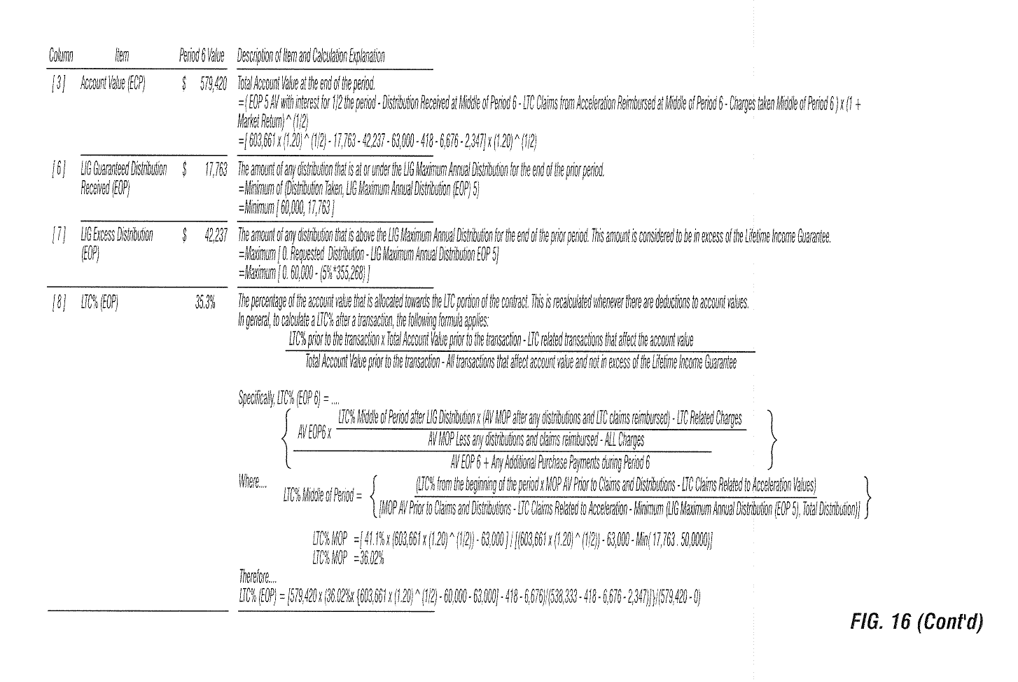

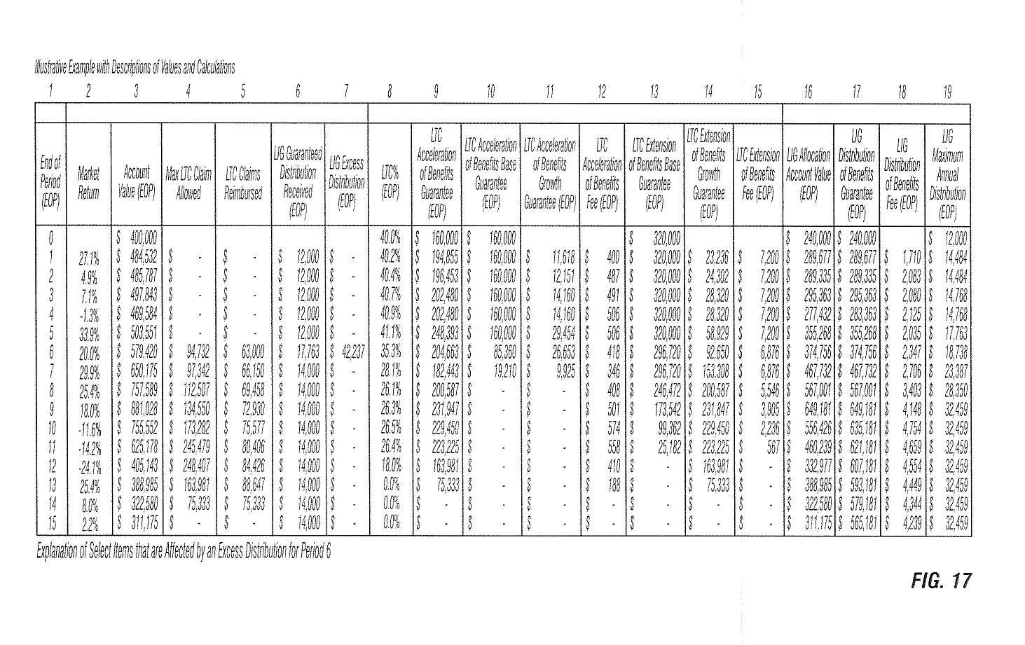

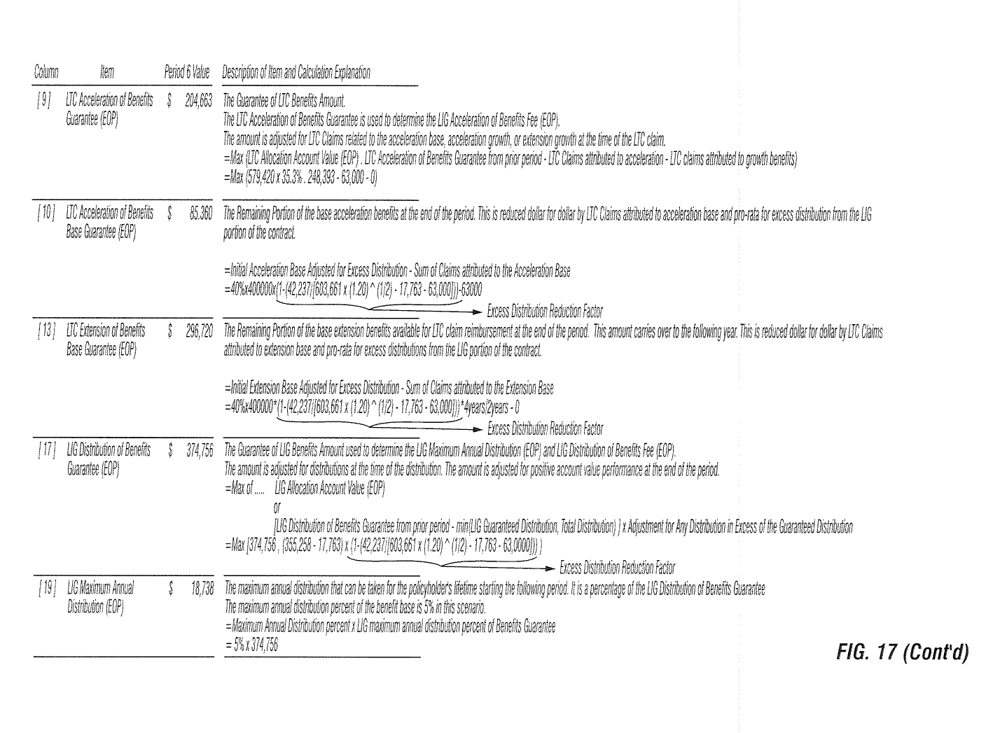

FIGS. 16 and 17 illustrate the impacts of an LIG excess distribution (i.e., a distribution other than payment of a long term care claim under the long term care benefit guarantee or a distribution under the income or withdrawal guarantee) on various values in the table. Specifically, FIGS. 16 and 17 illustrate the impacts of an LIG excess distribution in period six on the quantities in columns 3, 6, 8, 9, 10, 13, 17 and 19. For purposes of illustration, the total distribution for period six is assumed to be the $60,000.00. As indicated, $17,763.00 is the amount of the guaranteed distribution, while the balance ($42,237.00) is the excess distribution. The impacts of this excess distribution on total account value (column 3) and LTC percentage (column 8) are detailed in the text below the table in FIG. 16. The impacts of the excess distribution on the LTC acceleration of benefits guarantee (column 9), the LTC acceleration of benefits base guarantee (column 10), the LTC extension of benefits base guarantee (column 13), the LIG distribution of benefits guarantee (column 17) and the LIG maximum annual distribution (column 19) are described in the text below the table in FIG. 16.

FIGS. 12-15, LTC percentage (column 8) is calculated in accordance with the formulae set forth below the table on FIG. 13. In FIGS. 16 and 17, LTC percentage is calculated in accordance with the formulae in the text below the table on FIG. 16, illustrating the impact of an LIG excess distribution on this quantity. Although LTC percentage can be calculated through use of such formulae, other means for determining this quantity are contemplated. Specifically, LTC percentage can be determined by or based on, the following: a constant (set) percentage; a percentage that is reduced only by claims, not charges; a percentage that is reduced by LTC-related reimbursed claims and charges; or a formula based on any of the following: acceleration period, extension period, charges, interest earned, LTC claims reimbursed, LIG distributions, LTC acceleration of benefits guarantee, LTC extension of benefits base guarantee, or LTC acceleration of benefits base guarantee. A re-determination of LTC percentage can be performed once or multiple times during a period.

With reference to the LTC acceleration of benefits fee (column 12), this value can be calculated using a formula, such as the one set forth in the text below the table in FIG. 14. Alternatively, this value can be set as a constant amount. Either the formula-derived or constant amount can be based on the following: an asset based charge on the total account value; an asset based charge on the account value allocated to the LTC portion of the contract; a constant amount deduction from the LTC acceleration of benefits guarantee or the LTC acceleration of benefits base guarantee; a deduction from the LTC guarantee that is a percentage of the LTC acceleration of benefits base guarantee (this percentage can vary by duration of the contract); a percentage or constant charge from LTC reimbursements received; or a formula based on any one of the following: acceleration period, extension period, interest earned, LTC claims reimbursed, LIG distributions, LTC acceleration of benefits guarantee, LTC extension of benefits base guarantee, or LTC acceleration of benefits base guarantee. The fee can be charged once or multiple times during a period.

With reference to the LTC extension of benefits fee (column 15), this value can be calculated using a formula, such as the one set forth in the text below the table in FIG. 14. Alternatively, this fee may be set as a constant amount. Either the formula-derived value or the constant amount can be based on (but is not limited to) the following: an asset based charge on the total account value; an asset based charge on the account value allocated to the LTC portion of the contract; a constant amount deduction from the LTC acceleration of benefits guarantee, LTC extension of benefits base guarantee, or the LTC acceleration of benefits base guarantee; a deduction from the LTC guarantee that is a percentage of the LTC acceleration of benefits guarantee, LTC extension of benefits base guarantee, or LTC acceleration of benefits base guarantee (this percentage can vary by duration of the contract); a percentage or constant charge from LTC reimbursements received; or a formula based on any one of the following: acceleration period, extension period, interest earned, LTC claims reimbursed, LIG distributions, LTC extension of benefits base guarantee, or LTC acceleration of benefits base guarantee. The fee can be charged once or multiple times during a period.

In addition to the computerized method and computer system for administrating an investment account as described and illustrated above, embodiments of the invention further include computer readable media encoded with programming to accomplish the subject method and/or comprise part of the subject system described above.

The exemplifications set out herein illustrate certain embodiments of the invention, and such exemplifications are not to be construed as limiting the scope of the invention in any manner. Although the present invention has been described with reference to particular embodiments, and examples, from the foregoing description one skilled in the art can easily ascertain the essential characteristics of the invention, and various changes and modifications may be made to adapt the various uses and characteristics without departing from the spirit and scope of the invention.

What is claimed:

1. A computerized method for administering an investment account having an income or withdrawal guarantee and a long term care guarantee, comprising the steps of:
establishing an investment account having an account balance;
using a computer,
allocating a first portion of the account balance to fund a long term care benefit having a long term care benefit guarantee;
allocating a second portion of the account balance to fund an income or withdrawal benefit having an income or withdrawal benefit guarantee;
determining an amount of a periodic long term care benefit available for payment of long term care benefit claims under the long term care benefit guarantee; and
determining an amount of a periodic income or withdrawal benefit available for distribution under the income or withdrawal benefit guarantee.

2. The computerized method of claim 1, further comprising the step of determining a total amount available for payment of long term care benefit claims under the long term care benefit guarantee.

3. The computerized method of claim 2, further comprising the step of adjusting one or both of the periodic amount and the total amount available for payment of long term care benefit claims under the long term care benefit guarantee to reflect one or more of:
a) an amount of an allowable claim; and
b) investment results attributable to the first portion of the account balance.

4. The computerized method of claim 1, wherein said long term care benefit guarantee comprises a long term care acceleration of benefits guarantee.

5. The computerized method of claim 4, further comprising the step of determining a total amount available for payment of long term care benefit claims under the long term care acceleration of benefits guarantee.

6. The computerized method of claim 5, wherein the amount available for payment of long term care benefit claims under the long term care acceleration of benefits guarantee is initially set equal to, or substantially equal to, an amount of the first portion of the account balance.

7. The computerized method of claim 5, further comprising the step of periodically adjusting the amount available for payment of long term care benefit claims under the long term care acceleration of benefits guarantee to reflect one or more of:
a) an amount of an allowable claim paid under the long term care acceleration of benefits guarantee; and
b) investment results attributable to the first portion of the account balance.

8. The computerized method of claim 4, wherein said long term care benefit guarantee comprises a long term care extension of benefits guarantee.

9. The computerized method of claim 8, wherein an amount available for payment of long term care benefit claims under the long term care extension of benefits guarantee is equal to the amount available for payment of long term care benefit claims under the long term care acceleration of benefits guarantee multiplied by a positive numerical factor.

10. The computerized method of claim 9, wherein said factor is either one or two.

11. The computerized method of claim 8, further comprising the step of adjusting the total amount available for payment of long term care benefit claims under the long term care extension of benefits guarantee to reflect an amount of an allowable claim paid under the long term care extension of benefits guarantee.

12. The computerized method of claim 8, further comprising the step of adjusting the account balance to reflect a fee associated with the long term care benefit guarantee.

13. The computerized method of claim 8, further comprising the step of determining, in response to a long term care benefit claim, an amount of a long term care benefit payment.

14. The computerized method of claim 13, wherein the step of determining, in response to a long term care benefit claim, an amount of a long term care benefit payment comprises the step of comparing the benefit payment amount to the amount of a periodic long term care benefit available for payment of claims under the long term care benefit guarantee.

15. The computerized method of claim 13, further comprising the steps of determining whether the amount of the long term care benefit payment is payable under the acceleration of benefits guarantee or the extension of benefits guarantee, and adjusting the account balance of the investment account to reflect payment if the amount is payable under the long term care acceleration of benefits guarantee.

16. The computerized method of claim 2, further comprising the steps of allocating growth in the investment account to the first portion of the account balance, and increasing the amount available for payment of long term care benefit claims under the long term care benefit guarantee.

17. The computerized method of claim 2, further comprising the steps of allocating a first portion of growth in the investment account to the first portion of the account balance, and increasing the amount available for payment of long term care benefit claims under the long term care benefit guarantee.

18. The computerized method of claim 2, further comprising the step of adjusting one or both of the periodic amount and the total amount available for payment of long term care benefit claims under the long term care benefit guarantee by an adjustment factor.

19. The computerized method of claim 18, wherein said adjustment factor comprises an inflation factor, a cost of living factor, a fixed percentage rate factor, or a variable percentage rate factor.

20. The computerized method of claim 2, further comprising the steps of reallocating the account balance of the investment account to decrease the first portion of the account balance and to increase the second portion of the account balance, and decreasing one or both of the amount of a periodic long term care benefit, or the total amount, available for payment of long term care benefit claims under the long term care benefit guarantee.

21. The computerized method of claim 2, further comprising the steps of reallocating the account balance of the investment account to increase the first portion of the account balance and to decrease the second portion of the account balance, and increasing one or both of the amount of a periodic long term care benefit, or the total amount, available for payment of long term care benefit claims under the long term care benefit guarantee.

22. The computerized method of claim 1, wherein the first portion of the account balance is limited to a maximum of 50% of the account balance.

23. The computerized method of claim 1, further comprising the step of establishing a range comprising a minimum amount and a maximum amount of said first portion of the account balance.

24. The computerized method of claim 1, wherein the amount of a periodic long term care benefit available for payment of long term care benefit claims under the long term care benefit guarantee is fixed after a specified time period.

25. The computerized method of claim 24, wherein said specified time period is five years.

26. The computerized method of claim 1, wherein the amount of a periodic long term care benefit available for payment of long term care benefit claims under the long term care benefit guarantee is fixed after a specified time period, except for increases to reflect growth of the first portion of the account balance.

27. The computerized method of claim 1, further comprising the step of periodically determining an amount of an income or withdrawal benefit distribution.

28. The computerized method of claim 27, further comprising the step of adjusting the account balance of the investment account to reflect payment of the income or withdrawal benefit distribution.

29. The computerized method of claim 1, further comprising the steps of attributing growth in the investment account to the second portion of the account balance, and increasing the amount of a periodic income or withdrawal benefit available for distribution under the income or withdrawal benefit guarantee.

30. The computerized method of claim 1, further comprising the step of adjusting the amount of a periodic income or withdrawal benefit available for distribution under the income or withdrawal benefit guarantee by an adjustment factor.

31. The computerized method of claim 30, wherein said adjustment factor comprises an inflation factor, a cost of living factor, a fixed percentage rate factor, or a variable percentage rate factor.

32. The computerized method of claim 1, wherein the periodic income or withdrawal benefit having an income or withdrawal benefit guarantee is a lifetime benefit.

33. The computerized method of claim 1, further comprising the steps of reallocating the account balance of the investment fund to decrease the first portion of the account balance and to increase the second portion of the account balance, and increasing an amount of a periodic income or withdrawal benefit available for distribution under the income or withdrawal benefit guarantee.

34. The computerized method of claim 1, further comprising the steps of reallocating the account balance of the investment fund to increase the first portion of the account balance and to decrease the second portion of the account balance, and decreasing the amount of a periodic income or withdrawal benefit available for distribution under the income or withdrawal benefit guarantee.

35. The computerized method of claim 1, further comprising the steps of determining an amount of a distribution other than an income or withdrawal benefit distribution or a long term care benefit payment.

36. The computerized method of claim 35, further comprising the step of adjusting the amount of a periodic income or withdrawal benefit available for distribution under the income or withdrawal benefit guarantee in response to said distribution other than an income or withdrawal benefit distribution or a long term care benefit payment.

37. The computerized method of claim 35, further comprising the step of adjusting the amount of a periodic long term care benefit available for payment of long term care benefit claims under the long term care benefit guarantee in response to said distribution other than an income or withdrawal benefit distribution or a long term care benefit payment.

38. The computerized method of claim 1, further comprising the step of adjusting the account balance to reflect an additional deposit credited to the investment account.

39. The computerized method of claim 38, further comprising the step of adjusting one or both of the long term care benefit guarantee and the income or withdrawal benefit guarantee to reflect the additional deposit.

40. A computer system for administering an investment account having an income or withdrawal guarantee and a long term care guarantee, comprising:
a processor for performing calculations and processing data relating to an investment account having an account balance;
a storage element for storing data and an electronic record relating to the account;
a display device for displaying the electronic record;
an input device for inputting data relating to the account; and
a program executable by the processor to cause the processor to:
allocate a first portion of the account balance to fund a long term care benefit having a long term care benefit guarantee;
allocate a second portion of the account balance to fund an income or withdrawal benefit having an income or withdrawal benefit guarantee;
determine an amount of a periodic long term care benefit available for payment of long term care benefit claims under the long term care benefit guarantee; and
determine an amount of a periodic income or withdrawal benefit available for distribution under the income or withdrawal benefit guarantee.

41. The computer system of claim 40, wherein the program causes the processor to determine a total amount available for payment of long term care benefit claims under the long term care benefit guarantee.

42. The computer system of claim 41, wherein the program causes the processor to adjust one or both of the periodic amount and the total amount available for payment of long term care benefit claims under the long teen care benefit guarantee to reflect one or more of:
a) an amount of an allowable claim; and
b) investment results attributable to the first portion of the account balance.

43. The computer system of claim 40, wherein said long term care benefit guarantee comprises a long term care acceleration of benefits guarantee.

44. The computer system of claim 43, wherein the program causes the processor to determine a total amount available for payment of long term care benefit claims under the long term care acceleration of benefits guarantee.

45. The computer system of claim 44, wherein the amount available for payment of long term care benefit claims under the long term care acceleration of benefits guarantee is initially set equal to, or substantially equal to, an amount of the first portion of the account balance.

46. The computer system of claim 44, wherein the program causes the processor to periodically adjust the amount available for payment of long term care benefit claims under the long term care acceleration of benefits guarantee to reflect one or more of:
a) an amount of an allowable claim paid under the long term care acceleration of benefits guarantee; and
b) investment results attributable to the first portion of the account balance.

47. The computer system of claim 43, wherein said long term care benefit guarantee comprises a long term care extension of benefits guarantee.

48. The computer system of claim 47, wherein an amount available for payment of long term care benefit claims under the long term care extension of benefits guarantee is equal to the amount available for payment of long term care benefit claims under the long term care acceleration of benefits guarantee multiplied by a positive numerical factor.

49. The computer system of claim 48, wherein said factor is either one or two.

50. The computer system of claim 47, wherein the program causes the processor to adjust the total amount available for payment of long teen care benefit claims under the long term care extension of benefits guarantee to reflect an amount of an allowable claim paid under the long term care extension of benefits guarantee.

51. The computer system of claim 47, wherein the program causes the processor to adjust the account balance to reflect a fee associated with the long term care benefit guarantee.

52. The computer system of claim 47, wherein the program causes the processor to determine, in response to a long term care benefit claim, an amount of a long term care benefit payment.

53. The computer system of claim 52, wherein the program causes the processor to compare the benefit payment amount to the amount of a periodic long term care benefit available for payment of claims under the long term care benefit guarantee.

54. The computer system of claim 52, wherein the program causes the processor to determine whether the amount of the long term care benefit payment is payable under the acceleration of benefits guarantee or the extension of benefits guarantee, and adjust the account balance of the investment account to reflect payment of the long term care benefit claim under the long term care acceleration of benefits guarantee.

55. The computer system of claim 41, wherein the program causes the processor to allocate growth in the investment account to the first portion of the account balance, and increase the amount available for payment of long term care benefit claims under the long term care benefit guarantee.

56. The computer system of claim 41, wherein the program causes the processor to allocate a first portion of growth in the investment account to the first portion of the account balance, and increase the amount available for payment of long term care benefit claims under the long term care benefit guarantee.

57. The computer system of claim 41, wherein the program causes the processor to adjust one or both of the periodic amount and the total amount available for payment of long term care benefit claims under the long term care benefit guarantee by an adjustment factor.

58. The computer system of claim 57, wherein said adjustment factor comprises an inflation factor, a cost of living factor, a fixed percentage rate factor, or a variable percentage rate factor.

59. The computer system of claim 41, wherein the program causes the processor to reallocate the account balance of the investment account to decrease the first portion of the account balance and to increase the second portion of the account balance, and decrease one or both of the amount of a periodic long term care benefit, or the total amount, available for payment of long term care benefit claims under the long term care benefit guarantee.

60. The computer system of claim 41, wherein the program causes the processor to reallocate the account balance of the investment account to increase the first portion of the account balance and to decrease the second portion of the account balance, and increase one or both of the amount of a periodic long term care benefit, or the total amount, available for payment of long term care benefit claims under the long term care benefit guarantee.

61. The computer system of claim 40, wherein the first portion of the account balance is limited to a maximum of 50% of the account balance.

62. The computer system of claim 40, wherein the program causes the processor to establish a range comprising a minimum amount and a maximum amount of said first portion of the account balance.

63. The computer system of claim 40, wherein the amount of a periodic long term care benefit available for payment of long term care benefit claims under the long term care benefit guarantee is fixed after a specified time period.

64. The computer system of claim 63, wherein said specified time period is five years.

65. The computer system of claim 63, wherein the amount of a periodic long term care benefit available for payment of long term care benefit claims under the long term care benefit guarantee is fixed after a specified time period, except for increases to reflect growth of the first portion of the account balance.

66. The computer system of claim 40, wherein the program causes the processor to periodically determine an amount of an income or withdrawal benefit distribution.

67. The computer system of claim 66, wherein the program causes the processor to adjust the account balance of the investment account to reflect payment of the income or withdrawal benefit distribution.

68. The computer system of claim 40, wherein the program causes the processor to attribute growth in the investment account to the second portion of the account balance, and increase the amount of a periodic income or withdrawal benefit available for distribution under the income or withdrawal benefit guarantee.

69. The computer system of claim 40, wherein the program causes the processor to adjust the amount of a periodic income or withdrawal benefit available for distribution under the income or withdrawal benefit guarantee by an adjustment factor.

70. The computer system of claim 69, wherein said adjustment factor comprises an inflation factor, a cost of living factor, a fixed percentage rate factor, or a variable percentage rate factor.

71. The computer system of claim 40, wherein the periodic income or withdrawal benefit having an income or withdrawal benefit guarantee is a lifetime benefit.

72. The computer system of claim 40, wherein the program causes the processor to reallocate the account balance of the investment fund to decrease the first portion of the account balance and to increase the second portion of the account balance, and increase an amount of a periodic income or withdrawal benefit available for distribution under the income or withdrawal benefit guarantee.

73. The computer system of claim 40, wherein the program causes the processor to reallocate the account balance of the investment fund to increase the first portion of the account balance and to decrease the second portion of the account balance, and decrease the amount of a periodic income or withdrawal benefit available for distribution under the income or withdrawal benefit guarantee.

74. The computer system of claim 40, wherein the program causes the processor to determine an amount of a distribution other than an income or withdrawal benefit distribution or a long term care benefit payment.

75. The computer system of claim 74, wherein the program causes the processor to adjust the amount of a periodic income or withdrawal benefit available for distribution under the income or withdrawal benefit guarantee in response to said distribution other than an income or withdrawal benefit distribution or a long term care benefit payment.

76. The computer method of claim 74, wherein the program causes the processor to adjust the amount of a periodic long term care benefit available for payment of long term care benefit claims under the long term care benefit guarantee in response to said distribution other than an income or withdrawal benefit distribution or a long term care benefit payment.

77. The computer system of claim 40, wherein the program causes the processor to adjust the account balance to reflect an additional deposit credited to the investment account.

78. The computer system of claim 77, wherein the program causes the processor to adjust one or both of the long term care benefit guarantee and the income or withdrawal benefit guarantee to reflect the additional deposit.

79. A non-transitory computer readable storage medium having executable program code stored thereon for causing the computer to perform steps for processing and administering an investment account having an account balance and having an income or withdrawal guarantee and a long term care guarantee, the steps comprising:
allocating a first portion of the account balance to fund a long term care benefit having a long term care benefit guarantee;
allocating a second portion of the account balance to fund an income or withdrawal benefit having an income or withdrawal benefit guarantee;
determining an amount of a periodic long term care benefit available for payment of long term care benefit claims under the long term care benefit guarantee; and
determining an amount of a periodic income or withdrawal benefit available for distribution under the income or withdrawal benefit guarantee.

80. The computer-readable medium of claim 79, wherein said long term care benefit guarantee comprises a long term care acceleration of benefits guarantee.

81. The computer-readable medium of claim 80, further comprising the step of determining a total amount available for payment of long term care benefit claims under the long term care acceleration of benefits guarantee.

82. The computer-readable medium of claim 81, wherein the amount available for payment of long term care benefit claims under the long term care acceleration of benefits guarantee is based on an amount of the first portion of the account balance.

83. The computer-readable medium of claim 80, wherein said amount of a periodic long term care benefit available for payment of long term care benefit claims under the long term care benefit guarantee comprises an amount of a periodic long term care benefit available for payment of long term benefit claims under the long term care acceleration of benefits guarantee.

84. The computer-readable medium of claim 83, wherein said amount of a periodic long term care benefit available under the long term care acceleration of benefits guarantee is determined by dividing a total amount available for payment of long term care benefit claims under the long term care acceleration of benefits guarantee by one or more periods to determine the amount of the periodic benefit for at least a predetermined number of initial benefit periods.

85. The computer-readable medium of claim 84, wherein after the predetermined number of benefit periods, the amount of the periodic long term care benefit available for payment of long term care benefit claims under the long term care acceleration of benefits guarantee is fixed.

86. The computer-readable medium of claim 79, wherein said long term care benefit guarantee comprises a long term care extension of benefits guarantee.

87. The computer-readable medium of claim 86, further comprising the step of determining a fee associated with the long term care extension of benefits guarantee.

88. The computer-readable medium of claim 79, wherein an amount available for payment of long term care benefit claims under the long term care extension of benefits guarantee is based on an amount of the first portion of the account balance.
